(19) United States
(12) Patent Application Publication
(10) Pub. No.: US 2002/0071407 A1
(43) Pub. Date: Jun. 13, 2002

(54) HARQ method in a CDMA mobile communication system

(75) Inventors: Chang-Hoi Koo, Songnam-shi (KR); Kyou-Woong Kim, Suwon-shi (KR); Hwan-Joon Kwon, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/901,502

(22) Filed: Jul. 9, 2001

(30) Foreign Application Priority Data
Jul. 8, 2000 (KR) 39136/2000
Aug. 17, 2000 (KR) 47622/2000
Aug. 24, 2000 (KR) 49082/2000
Sep. 7, 2000 (KR) 53104/2000
Sep. 8, 2000 (KR) 53549/2000

(51) Int. Cl. H04B 7/216

(52) U.S. Cl. 370/335; 370/342

(57) ABSTRACT

Disclosed is a method for transmitting packet data and side information including a sequence number of the packet data in a CDMA mobile communication system employing a HARQ scheme for performing retransmission in response to a retransmission request message after initial transmission. The method comprises transmitting the packet data and the side information over a dedicated channel during the initial transmission; and transmitting the packet data and the side information over a common channel during the retransmission. The dedicated channel is a dedicated physical channel (DPCH), and the common channel is a physical downlink shared channel (DSCH).

### BACKGROUND OF THE INVENTION

1. Field of the Invention

The present invention relates generally to a data transmission method in a mobile communication system, and in particular, to a method for retransmitting data having a transmission error.

2. Description of the Related Art

For forward data communication in a mobile communication system, a UE (User Equipment) is assigned a forward (or downlink) dedicated channel (DCH) from a UTRAN (UMTS Terrestrial Radio Access Network) and receives data over the assigned downlink dedicated channel. Here, the mobile communication system refers to an ISDN (Integrated Services Digital Network) system, a digital cellular system, a W-CDMA (Wideband Code Division Multiple Access) system, a UMTS (Universal Mobile Telecommunication System) system and an IMT-2000 (International Mobile Telecommunication-2000) system. If no error is detected from the received packet data, the UE provides the received packet data to an upper layer. However, upon detecting an error from the received packet data, the UE sends a retransmission request message for the failed packet data to the UTRAN (or Node B) using a HARQ (Hybrid Automatic Repeat (or Retransmission) reQuest) scheme. The “HARQ scheme” refers to a retransmission scheme using every type of an ARQ (Automatic Repeat (or Retransmission) reQuest) scheme which sends a retransmission request message upon detecting an FEC (Forward Error Correction) code and an error. The HARQ scheme is designed to increase data transmission efficiency, i.e., throughput, and to improve system performance using a channel coding scheme.

Operation of the general HARQ scheme will be described below with reference to the accompanying drawings.

FIG. 1 illustrates a packet data retransmission process in the general HARQ scheme, In particular, FIG. 1 illustrates a process for retransmitting a packet data through the same dedicated channel as that used during initial transmission upon detecting an error from initially received packet data.

Referring to FIG. 1, a UE receives initial packet data transmitted from a Node B (Step 101), and determines whether an error has occurred in the received initial packet data (Step 102). Upon detecting an error from the initial packet data, the UE sends a retransmission request message NAK (Negative Acknowledgement) for the initial packet data to the Node B (Step 103). The retransmission request message NAK includes packet ID (IDentification) information including a version number and a sequence number. By analyzing the received retransmission request message NAK, the Node B acquires information on the packet data to retransmit. Upon receipt of the retransmission request message NAK from the UE (Step 104), the Node B retransmits requested packet data specified in the retransmission request message NAK to the UE through the same dedicated channel as that used when the Node B has transmitted the initial packet data (Step 105). Though not illustrated in FIG. 1, upon receipt of error-free packet data, the UE transmits an ACK (Acknowledgement) signal with the packet ID information to the Node B.

Further, though not illustrated in FIG. 1, the above-stated retransmission process is repeated as many times as a predetermined retransmission frequency, or until the UE transmits an ACK signal after successful decoding. Therefore, in the retransmission process of FIG. 1, if an error is continuously detected, i.e., if the channel environment is bad, a time required in transmitting one packet data block is increased, drastically decreasing the overall throughput. In addition, since the HARQ scheme actually operates in a Selective-Repeat ARQ mode, the Node B continuously transmits the packet data no matter whether the packet data has a transmission error. Therefore, upon receipt of the packet ID information, i.e., a version number and a sequence number of the failed (or damaged) packet data from the UE, the Node B repeats the process for retransmitting only the failed packet data having a transmission error.

FIGS. 2A and 2B illustrate several examples of a process flow for retransmitting packet data in the general HARQ scheme of a mobile communication system, which is assumed herein to include one Node B and two UEs (UE_A and UE_B). Specifically, FIGS. 2A and 2B show a process flow for transmitting downlink packet data from the Node B to the UE, sending a retransmission request message NAK to the Node B upon UE's detecting an error from the received downlink packet data, and retransmitting the failed packet data from the Node B to the UE. Here, it is noted that the packet data is transmitted over the same downlink dedicated channel during both initial transmission and retransmission.

Referring first to FIG. 2A, the Node B transmits packet data blocks to the UE_A at stated periods (Step 201), and the UE_A then receives the packet data blocks transmitted from the Node B (Step 202). If an error occurs while the Node B transmits the packet data block #2 (Step 203), the UE_A perceives that an error has occurred in the packet data block #2. Upon detecting an error, the UE_A transmits to the Node B a retransmission request message NAK#2 for requesting retransmission of the failed packet data block #2 (Step 204). Upon receipt of the retransmission request message NAK#2, the Node B retransmits the packet data block #2 in response to the received retransmission request message NAK#2 (Step 208). After retransmitting the packet data block #2, the Node B continues to transmit the next packet data block #4 succeeding the packet data block #3 at the stated periods (Step 210). At the same time, the UE_A decodes the received packet data block #2 retransmitted from the Node B (Step 209) and then, decodes the next received packet data block #4 (Step 211).

FIG. 2A shows a case where the packet retransmission process is completed by retransmitting the failed packet data once in the general HARQ scheme. However, in some cases, the UE may not decode specific packet data with a single retransmission of the failed packet data by the Node B.

Referring to FIG. 2B, the Node B transmits a packet data block #1 to the UE_B (Step 231). Upon receipt of the packet data block #1, the UE_B perceives that an error has occurred in the received packet data block #1, and then, transmits a retransmission request message NAK#1 to the Node B (Step 233). While transmitting consecutive packet data blocks at stated periods, the Node B receives the retransmission request message NAK#1 (Step 236). Upon receipt of the retransmission request message NAK#1, the Node B retransmits the packet data block #1 (Step 237). Upon receipt of the retransmitted packet data block #1, the UE_B perceives that an error has occurred in the received retransmitted packet data block #1, and transmits to the Node B the retransmission request message NAK#1 for requesting retransmission of the packet data block #1 (Step 240). Upon receipt of the retransmission request message NAK#1 (Step 243), the Node B retransmits the packet data block #1 in response to the received retransmission request message NAK#1 (Step 244). The UE_B decodes the received packet data block #1 retransmitted twice from the Node B (Step 247), and thereafter, decodes the next received packet data block #4 (Step 242).

In FIGS. 2A and 2B, the UE_A is different from the UE_B in a time required in transmitting one packet data block. This is because the distance between the Node B and the UE_A is different from the distance between the Node B and the UE_B.

FIG. 3 illustrates a multi-layered structure of the general HARQ scheme and an operation of the same. Specifically, FIG. 3 illustrates a process for adding a CRC (Cyclic Redundancy Check) code to each of a transmission message part MESSAGE and a header HEADER having associated side information (or control information) through different transport channels, performing channel coding, rate matching and multiplexing on the CRC-added message and header, respectively, and then, interleaving the multiplexed data before transmission. Here, the “message” includes both of newly arrived packet data and retransmission packet data. Since the message and the header are subjected to the channel coding and rate matching through the different transport channels, a decoding success probability of the message may be different from a decoding success probability of the header at the Node B. That is, it is possible to reduce a decoding error rate of the header which is regarded as being more important than the message. At present, regarding the transport channel structure for the HARQ scheme in the W-CDMA system, one plan to transmit the actual user message and the header information having the side information with independent transport channels and another plan to transmit the header information and the message using the same transport channel are under debate, but the decision is not made yet.

Referring to FIG. 3, in steps 301 and 302, a transmission message and a header including side information for the transmission message are provided to a physical layer through different transport channels. A CRC code is added to each of the message and the header in step 303, and the CRC-added message and header are subjected to channel coding in step 304. The channel-coded message and header are subjected to rate matching by repetition and puncturing in step 305, and then, multiplexed in step 306. The multiplexed data is subjected to interleaving in step 307. The interleaved data is provided to a physical channel through a coded composite transport channel CCTrCH in step 308, and is mapped with the physical channel in step 309. The HARQ scheme then transmits the resulting packet data to the respective UEs in step 310. Reference number 311 indicates a plurality of UEs, implying that one Node B communicates with a plurality of UEs.

To sum up, the UE transmits a retransmission request message NAK for requesting the Node B to retransmit the failed packet data according to the general HARQ technique. Upon receipt of the retransmission request message NAK, the Node B retransmits the requested packet data over the existing downlink channel. At this moment, if a dedicated channel is established between the Node B and the UE (i.e., a CELL_DCH state), the downlink packet data will be transmitted through the dedicated channel (DCH). The conventional data retransmission method for retransmitting the failed packet data over the same channel as that used during initial transmission has the following disadvantages.

First, upon receipt of packet data fitting for its buffer size or window size, the receiver (or UE) must transmit the received packet data to an upper layer, so that the transmitter (or Node B) should quickly retransmit the failed packet data. Therefore, if the retransmission is performed through the same channel (e.g, the same DCH) as that used during initial transmission, a transmission time of the retransmitted packet data is determined depending on an amount of other packet data transmitted initially, causing an increase in a delay time.

Second, the delay time and the data communication throughput that one UE can expect by retransmitting the failed packet data through the same channel as that used during the initial transmission may be affected by the channel environment during the initial transmission. For example, if the channel environment is abruptly deteriorated, the packet data received by the UE will have many errors. As a result, the Node B must retransmit an increased amount of the failed packet data, causing a drastic decrease in a passing rate and an increase in the delay time. When the passing rate and the delay, time are very sensitive to the channel environment as stated above, it is not possible to provide a service requiring higher throughput or a service relatively susceptible to the delay time.

Third, it is difficult to control the quality of a service (QoS) between the initial packet data and the retransmitted packet data since the failed packet data is retransmitted using the same channel as that used during the initial transmission. That is, it is not possible to efficiently control the quality of services performed on the respective transport channels since the same physical channel and transport channel are used.

Fourth, since the failed packet data is retransmitted over the same channel as that used during the initial transmission, the UE must store some of other packet data continuously transmitted at stated periods from the Node B for soft symbol combining until it receives error-free packet data retransmitted from the Node B. This causes an increase in memory capacity for buffering in Layer 1 L1 of the UE (UE-L1). Therefore, an increase in the processing delay time of the retransmitted packet data causes a drastic increase in the required memory capacity of the UE, increasing the cost of the UE.

Due to the foregoing problems, a separate channel structure for retransmitting the initially transmitted packet data upon receipt of the retransmission request is required.

FIG. 14 illustrates multi-layered interfacing in the general HARQ scheme. In particular, FIG. 14 illustrates an existing call processing operation for transmitting side information of the HARQ scheme, wherein an RLC (Radio Link Control) layer transmits side information (or control information) received from the physical layer to an RRC, (Radio Resource Controller) layer, and the RRC layer transmits side information received from the RLC layer to the physical layer. In the case of FIG. 14, side information SI and user information UI are transmitted over two different transport channels, and the 2 transport channels are mapped with one dedicated physical channel (DPCH). When user information UI and side information SI are generated, the RLC layer transmits a primitive, i.e. an interface message inter layer, for the generated user information to a MAC-D (Medium Access Control-Dedicated channel) layer (Step 1411), and transmits a primitive for the side information for controlling the user information to the MAC-D layer (Step 1413). Here, the “primitive” exchanged between the RLC layer and the MAC-D layer indicates information on the logical channel.

Further, FIG. 14 illustrates a structure in which one RLC layer transmits the side information SI and the user information UI through two separate transport channels. This means that one RLC layer controls 2 transport channels. A MAC layer is divided into the MAC-D layer and a MAC-C/SH layer. The MAC-D layer controls the dedicated channel, while the MAC-C/SH layer controls the common or shared channel. Upon receipt of the user information and the side information from the RLC layer, the MAC-D layer transmits primitives for the received user information and side information to the physical layer of the Node B (Node B-L1) (Steps 1415 and 1417). Here, the Node B-L1 serves as the BTS (Base station Transceiver Subsystem) in the cdma200 system. Further, since a dedicated traffic channel (DTCH) is used in steps 1411 and 1413, the MAC-C/SH layer is bypassed.

Upon receipt of the primitives for the user information and the side information, the Node B-L1 actually controls a physical channel between the Node B and the UE through a Uu interface which is an air interface between the Node B and the UE (Step 1419). Here, a dedicated physical channel (DPCH) is used for the physical channel, and the DPCH is comprised of a dedicated physical control channel (DPCCH) and a dedicated physical data channel (DPDCH). The DPDCH is a physical channel for transmitting the user information and the side information, while the DPCCH is a physical channel for transmitting side information used for transmitting the DPDCH channel. Upon receipt of the DPCH through the physical layer after establishment of the physical channel between the Node B and the UE, the UE transmits to the MAC-D layer a primitive indicating that its physical layer has received the DPCH (Step 1421). That is, the UE, by using the primitives, transmits to the MAC-D layer side information SI used for storing the received user information UI in the physical layer and controlling the user information UI. The side information transmitted to the MAC-D layer includes a sequence number and a version number of RLC-PDU (Radio Link Control-Packet Data Unit) stored in the UE's physical layer.

Thereafter, the MAC-D layer transmits a primitive representative of the received side information SI to the UE's RLC layer (Step 1423). Here, the primitive transmitted from the MAC-D layer to the RLC layer is actually created and added by the Node,B's RLC layer, so that the side information added by the Node B's RLC layer is analyzed by the UE's RLC layer. The side information analyzed by the UE's RLC layer is information actually used in the physical layer, and is used for correct decoding of the RLC-PDU stored in the physical layer. The RLC layer transmits the analyzed information to an RRC (Radio Resource Control layer) (Step 1425), and the RRC layer transmits the information received from the RLC layer to the UE's physical layer (Step 1427). Upon receipt of the information from the RRC layer, the physical layer processes the currently stored RLC-PDU by analyzing the received information and then transmits the processed RLC-PDU to the MAC-D layer (Step 1429). At this point, only the RLC-PDU corresponding to the pure user information, not the side information, is transmitted to the MAC-D layer. Upon receipt of the user information from the physical layer, the MAC-D layer transmits the received user information to the RLC layer (Step 1431). The RLC layer then generates an ACK signal if the user information received from the MAC-D layer is determined as error-free packet data RLC-PDU. Otherwise, if the user information received from the MAC-D layer is determined as failed RLC-PDU, the RLC layer generates a NAK signal. The generated ACK or NAK signal is transmitted to the Node B's RLC layer (Step 1433). If the Node B's RLC layer receives the NAK signal, it performs the retransmission process on the failed RLC-PDU. Here, the NAK signal becomes a retransmission request message for requesting transmission of the failed packet data (RLC-PDU).

As described above, the process where the RRC layer transmits the primitive to the physical layer each time it receives the user information in an RLC-PDU unit, must pass (1) a process where the physical layer stores the user information and transmits the side information to the MAC layer, and the MAC layer sends the side information to the RLC layer, (2) a process where the RLC layer analyzes a sequence number and a version number of the received side information and sends the analyzed information to the RRC layer, and (3) a process where the RRC layer transmits the information received from the RLC layer back to the physical layer to report the sequence number and the version number of the currently received user information. In this case, each time the RRC layer receives the user information, it must transmit a primitive to the physical layer to provide the side information, resulting in an increase in system load and complexity of the RRC layer. In addition, when the RRC layer provides information to the physical layer by generating the primitive, it must not fundamentally generate the primitive except in an initial process where a call or the physical channel is set up, thereby causing an increase in system load and deterioration in system performance.

The side information generated in the Node B's RLC layer must be analyzed in the UE's RLC layer, and the process for transmitting the information analyzed in the RLC layer back to the physical layer through the upper layer may cause signal generation for interfacing between the layers, increasing the system load. As a result, the delay time required for processing the user information of the RLC-PDU stored in the physical layer is increased undesirably.

### SUMMARY OF THE INVENTION

It is, therefore, an object of the present invention to provide a method for retransmitting packet data through a new retransmission channel different from a channel used during initial transmission in a HARQ scheme.

It is another object of the present invention to provide a packet data retransmission method having a higher priority and a higher quality, compared with initial transmission, in a HARQ scheme.

It is further another object of the present invention to provide a packet data retransmission method for increasing throughput of a downlink and reducing a processing delay time, using a retransmission channel different from a channel used during initial transmission, in a HARQ scheme.

It is yet another object of the present invention to provide a packet data retransmission method for preventing an increase in a required memory capacity due to repeated retransmissions, using a retransmission channel different from a channel used during initial transmission, in a HARQ scheme.

It is still another object of the present invention to provide a packet data retransmission method for preventing delay in transmitting retransmission packet data by providing a direct interface between an RLC layer and a physical layer during retransmission of failed packet data in a HARQ scheme.

To achieve the above and other objects, there is provided a method for transmitting user information of packet data and side information including a sequence number of the packet data in a CDMA mobile communication system employing a HARQ scheme for performing retransmission in response to a retransmission request message after initial transmission. The method comprises transmitting the user information and the side information over a dedicated channel during the initial transmission; and transmitting the user information and the side information over a common channel during the retransmission.

Preferably, the dedicated channel is a dedicated physical channel (DPCH), and the common channel is a physical downlink shared channel (DSCH).

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a packet data retransmission process in a general H,ARQ scheme;

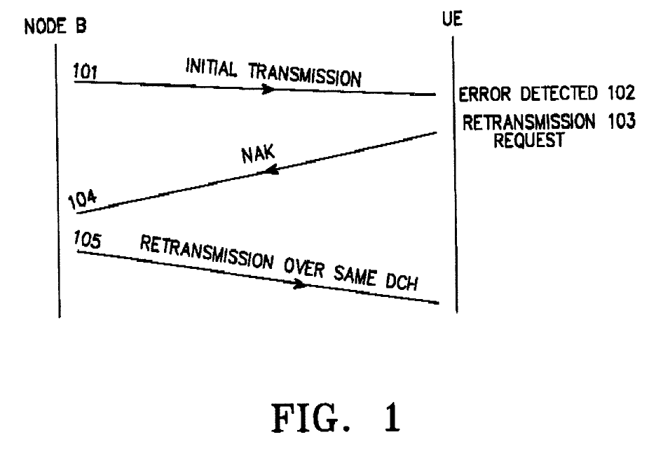

FIGS. 2A and 2B illustrate several examples of a process flow for retransmitting packet data in the general HARQ scheme;

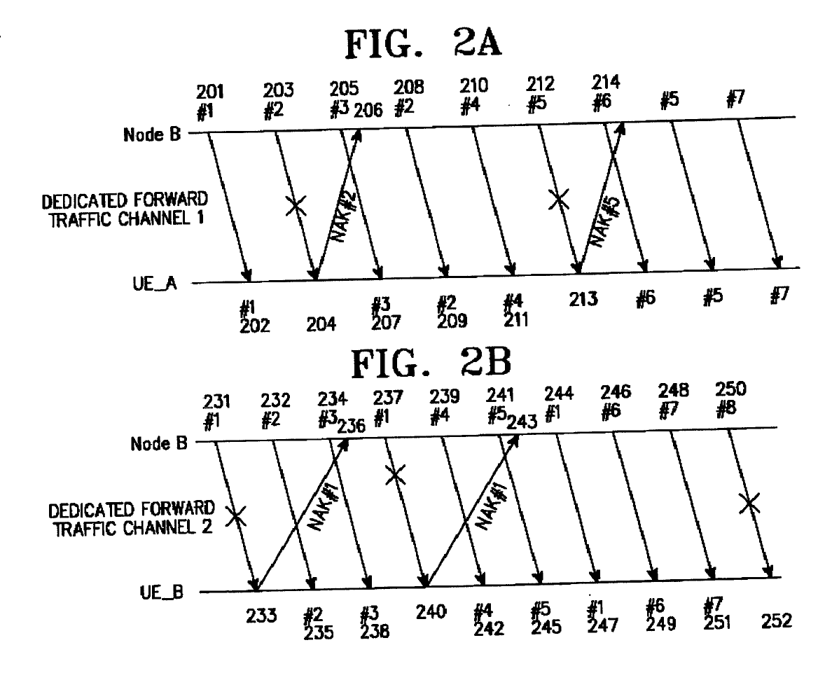

FIG. 3 is a diagram illustrating a multi-layered structure of the general HARQ scheme and an operation of the same;

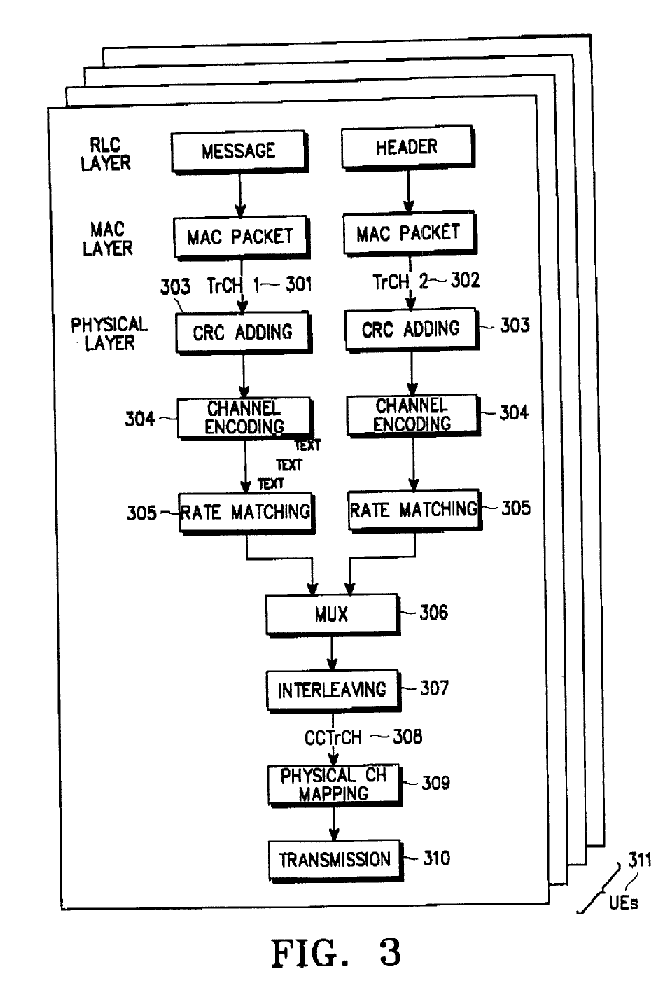

FIG. 4 illustrates a packet data retransmission process in a HARQ scheme according to an embodiment of the present invention;

FIGS. 5A to 5C illustrate several examples of a process flow for retransmitting packet data in the HARQ scheme according to an embodiment of the present invention;

FIG. 6 illustrates a multi-layered structure of a HARQ scheme according to an embodiment of the present invention and an operation of the same;

FIG. 7 illustrates a downlink channel structure for retransmitting the packet data in a HARQ scheme according to another embodiment of the present invention;

FIG. 8 illustrates a downlink channel structure for initial transmission of the packet data in a HARQ scheme according to another embodiment of the present invention;

FIG. 9 illustrates a downlink channel structure for retransmission of the packet data in the HARQ scheme according to another embodiment of the present invention;

FIG. 10 illustrates a process for retransmitting downlink packet data in the HARQ scheme according to another embodiment of the present invention;

FIG. 11 illustrates an uplink channel structure for retransmission of the packet data in a HARQ scheme according to another embodiment of the present invention;

FIG. 12 illustrates an uplink channel structure for retransmission of the packet data in the HARQ scheme according to another embodiment of the present invention;

FIG. 13 illustrates a process for retransmitting uplink packet data in the HARQ scheme according to another embodiment of the present invention;

FIG. 14 illustrates multi-layered interfacing in the general HARQ scheme;

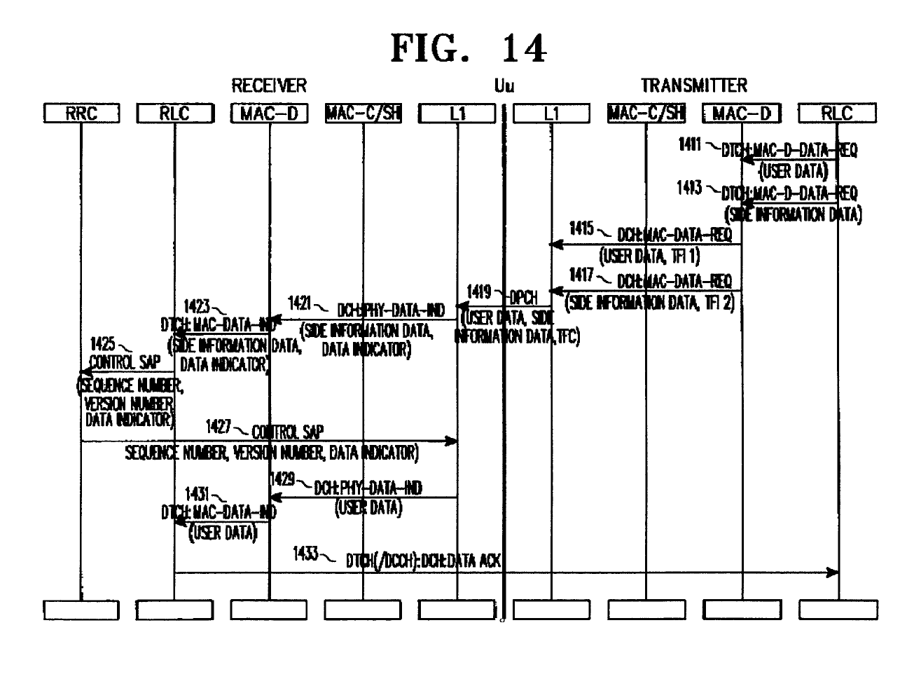

FIG. 15 illustrates multi-layered interfacing in a HARQ scheme according to another embodiment of the present invention;

FIG. 16 illustrates multi-layered interfacing in the HARQ scheme according another embodiment of the present invention;

FIG. 17 illustrates a downlink channel structure for retransmission of packet data in a HARQ scheme according to another embodiment of the present invention;

FIG. 18 illustrates a downlink channel structure for initial transmission and retransmission of the packet data in a HARQ scheme according to another embodiment of the present invention;

FIG. 19 illustrates a process for retransmitting the downlink packet data in a HARQ scheme according to another embodiment of the present invention;

FIG. 20 illustrates an uplink channel structure for retransmission of the packet data in a HARQ scheme according to another embodiment of the present invention;

FIG. 21 illustrates an uplink channel structure for retransmission of the packet data in a HARQ scheme according to another embodiment of the present invention;

FIG. 22 illustrates a process for retransmitting uplink packet data in the HARQ scheme according to another embodiment of the present invention;

FIG. 23 illustrates a downlink channel structure for retransmission of the packet data in a HARQ according to another embodiment of the present invention;

FIG. 24 illustrates a downlink channel structure for initial transmission of the packet data in a HARQ scheme according to another embodiment of the present invention;

FIG. 25 illustrates a downlink channel structure for retransmission of the packet data in a HARQ scheme according to another embodiment of the present invention;

FIG. 26 illustrates a process for retransmitting the downlink packet data in a HARQ scheme according to another embodiment of the present invention;

FIG. 27 illustrates an uplink channel structure for retransmission of the packet data in a HARQ scheme according to another embodiment of the present invention;

FIG. 28 illustrates an uplink channel structure for retransmission of the packet data in a HARQ scheme according to another embodiment of the present invention;

FIG. 29 illustrates a process for retransmitting uplink packet data in a HARQ scheme according to another embodiment of the present invention;

FIG. 30 illustrates a downlink channel structure for retransmission of the packet data in a HARQ according to another embodiment of the present invention;

FIG. 31 illustrates a downlink channel structure for initial transmission and retransmission of the packet data in a HARQ scheme according to another embodiment of the present invention;

FIG. 32 illustrates a process for retransmitting the downlink packet data in a HARQ scheme according to another embodiment of the present invention;

FIG. 33 illustrates an uplink channel structure for retransmission of the packet data in a HARQ scheme according to another embodiment of the present invention;

FIG. 34 illustrates an uplink channel structure for initial transmission and retransmission of the packet data in a HARQ scheme according to another embodiment of the present invention;

FIG. 35 illustrates a process for retransmitting uplink packet data in a HARQ scheme according to another embodiment of the present invention;

FIG. 36 illustrates a downlink channel structure for retransmission of the packet data in a HARQ scheme according to another embodiment of the present invention;

FIG. 37 illustrates a downlink channel structure for initial transmission of the packet data in a HARQ scheme according to another embodiment of the present invention;

FIG. 38 illustrates a downlink channel structure for retransmission of the packet data in a HARQ scheme according to another embodiment of the present invention; and

FIG. 39 illustrates a process for retransmitting the downlink packet data in a HARQ scheme according to another embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

In an exemplary embodiment of the present invention, upon receipt of a retransmission request message NAK from the UE, the Node B constructs a new retransmission channel having a higher channel quality and retransmits the failed packet data through the new retransmission channel, instead of retransmitting the failed packet data over a downlink (or forward) channel which was used in transmitting the initial packet data. By doing so, it is possible to decrease a probability that an error will occur again during retransmission. Further, downlink throughput and a delay time that a specific UE can expect by providing a new channel provided separately for retransmission, become less susceptible to the channel environment, thereby making it possible to support a service requiring higher downlink throughput and a service which is less sensitive to the time delay. Therefore, in the embodiment of the present invention, if the Node B and the UE are currently in a CELL_DCH state, the downlink channel for transmitting the initial packet data can become a downlink dedicated channel (DCH), and a downlink shared channel (DSCH) is used for the retransmission channel in the current W-CDMA system. Alternatively, the retransmission channel can also be comprised of a new physical channel and a new transport channel. Fundamentally, the retransmission channel according to the present invention is a newly constructed channel. However, when the failed packet data is retransmitted using the existing channel instead of setting up a new channel, the retransmission channel can become the DSCH.

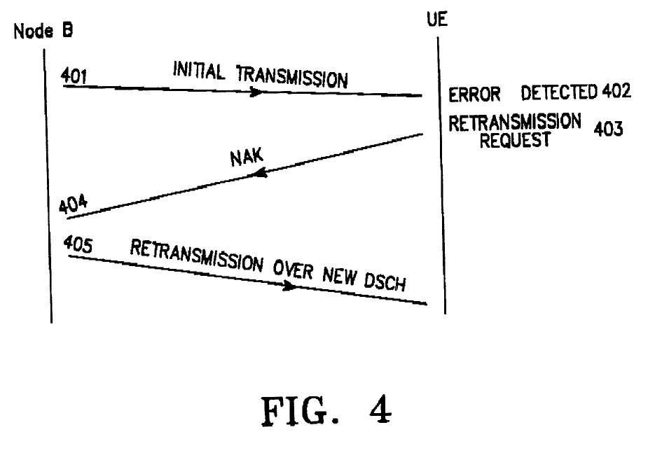

FIG. 4 illustrates a packet data retransmission process in a HARQ scheme according to an embodiment of the present invention. Specifically, FIG. 4 illustrates a process for attempting to retransmit failed packet data over a new retransmission channel instead of the same dedicated channel as that used during initial transmission by the Node B, upon receipt of a retransmission request message for the failed packet data received initially.

Referring to FIG. 4, the UE receives initial packet data transmitted from the Node B (Step 401), and determines whether an error has occurred in the received initial packet data (Step 402). Upon detecting an error from the initial packet data, the UE sends a retransmission request message NAK for the failed initial packet data to the Node B (Step 403). The Node B receives the retransmission request message NAK from the UE (Step 404). Though not illustrated in FIG. 4, upon receipt of error-free packet data, the UE transmits to the Node B an ACK signal including packet ID information including a version number and a sequence number of the received packet data. Upon receipt of the retransmission request message NAK, the Node B retransmits the requested packet data to the UE through the retransmission channel, e.g., a new DSCH (Step 405).

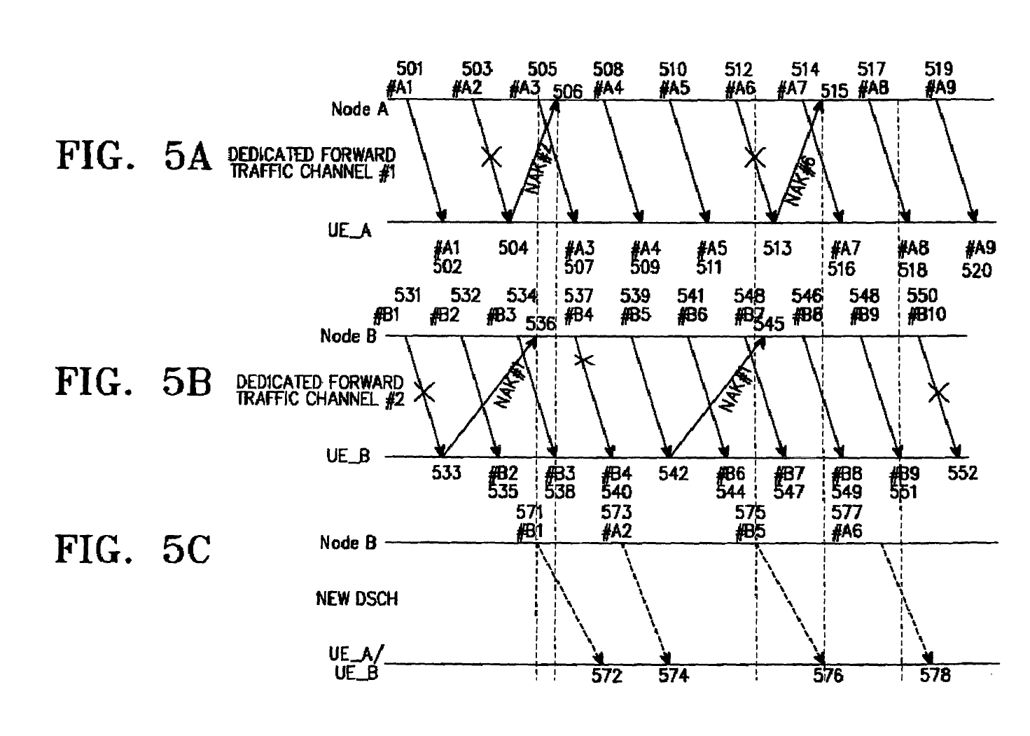

FIGS. 5A to 5C illustrate several examples of a process flow for retransmitting packet data in the HARQ scheme according to an embodiment of the present invention. The process as applied to a mobile communication system includes one Node B and two UEs (UE_A and UE_B), by way of example. In particular, FIGS. 5A and 5B show a process flow for sending a retransmission request message upon detecting an error from the received downlink packet data transmitted from the Node B to the UE, and FIG. 5C shows a process flow for retransmitting the retransmission-requested (i.e., failed) packet data. Here, it is noted that the packet data is transmitted over the different downlink dedicated channels during initial transmission and retransmission.

Referring first to FIG. 5A, the Node B transmits packet data blocks #A1-#A9 to the UE_A at stated periods, and the UE_A then receives the packet data blocks #A1-#A9 transmitted from the Node B. If errors occur while the Node B transmits the second and sixth packet data blocks #A2 and #A6 in steps 503 and 512, the UE_A detects the errors in steps 504 and 513. Upon detecting errors, the UE_A transmits to the Node B retransmission request messages NAK#A2 and NAK#A6 for the failed packet data blocks #A2 and #A6, respectively, in steps 506 and 515. Even after receipt of the retransmission request messages NAK#A2 and NAK#A6 from the UE_A, the Node B continuously transmits the packet data blocks at stated periods, and the UE_A also receives the packet data blocks at stated periods. That is, the Node B and the UE_A continuously exchange only the initial packet data blocks through the dedicated channel, regardless of the errors detected from the packet data blocks.

Next, referring to FIG. 5B, the Node B transmits a first packet data block #B1 to the UE_B in step 531. The UE_B detects an error occurred in the received packet data block #B1 in step 533, and transmits a retransmission request message NAK#B1 to the Node B in step 536. The operation is equally performed even on the fifth packet data block #B5. However, even after receipt of the retransmission request messages NAK#B1 and NAK#B5 from the UE_B, the Node B continuously transmits the packet data blocks at stated periods, and the UE_B also receives the packet data blocks at stated periods. That is, the Node B and the UE_B continuously exchange only the initial packet data blocks through the dedicated channel, regardless of the errors occurred in the packet data blocks.

Referring finally to FIG. 5C, the Node B designates a new retransmission channel for retransmitting the failed packet data block in response to the retransmission request message received from any one of the UEs (UE_A and UE_B). Here, the Node B designates a downlink shared channel (DSCH) as the retransmission channel different from initial transmission. Upon receipt of the retransmission request messages NAK#B1 and NAK#B5 for requesting retransmission of the first and fifth packet data blocks #B1 and #B5 from the UE_B as shown in FIG. 5B, the Node B transmits the retransmission-requested packet data blocks #B-1 and #B-5 over the designated DSCH in steps 571 and 575. Similarly, upon receipt of the retransmission request messages NAK#A2 and NAK#A6 for requesting retransmission of the second and sixth packet data blocks #A2 and #A6 from the UE_A as shown in FIG. 5A, the Node B transmits the requested packet data blocks #A-2 and #A-6 over the designated DSCH in steps 573 and 577.

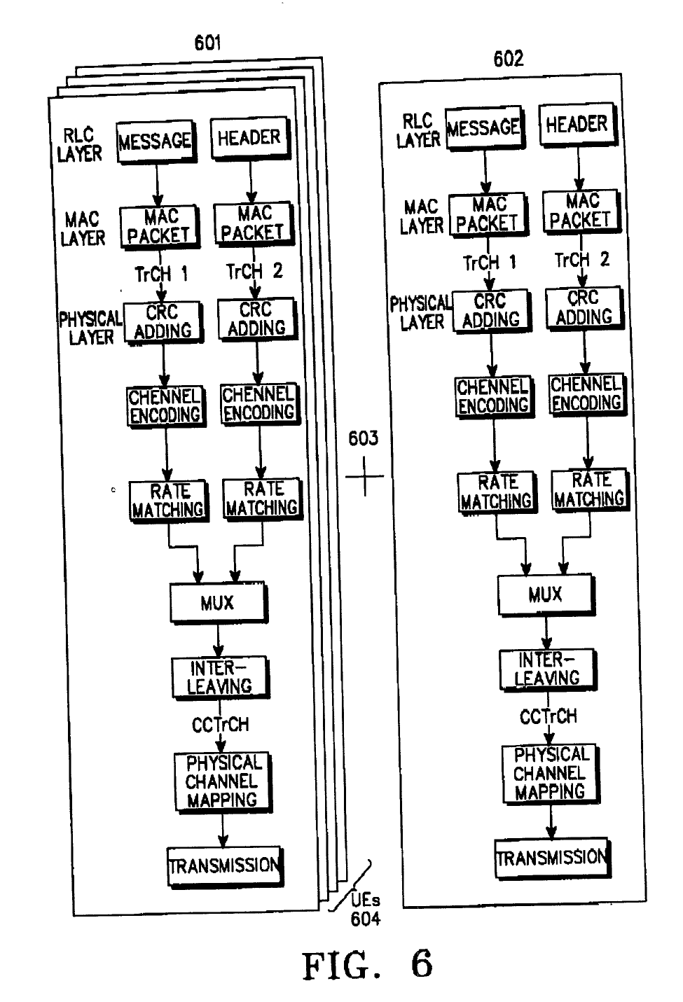

FIG. 6 illustrates a multi-layered structure of a HARQ scheme according to an embodiment of the present invention and an operation of the same. Specifically, FIG. 6 illustrates a multi-layered structure 601 for continuously transmitting new packet data blocks, and a multi-layered structure 602 for retransmitting the failed packet data blocks in response to the retransmission request messages.

Referring to FIG. 6, a transmission message and a header including side information for the transmission message are subjected to CRC adding, channel coding and rate matching through different transport channels, and then multiplexed into one signal. The multiplexed signal is transmitted after interleaving. Meanwhile, the retransmission-requested packet data is transmitted through another channel in the same process as the message and header processing process. Therefore, the message transmitted by the multi-layered structure 601 is comprised of only the initially transmitted packet data blocks, while the message transmitted by the multi-layered structure 602 is comprised of only the retransmitted packet data blocks. Reference numeral 603 of FIG. 6 indicates that the output of the multi-layered structure 601 and the output of the multi-layered structure 602 are transmitted through different channels.

Now, operation of the embodiment will be described in detail with reference to FIGS. 5A to 6.

The Node B initially transmits the first packet data block #A1 having a sequence number #1 to the UE_A through the downlink dedicated channel (DCH) in step 501. Transmitting the new packet data in the Node B is performed by the structure 601 of FIG. 6. The UE_A successfully receives the first packet data block #A1 transmitted from the Node B and decodes the received packet data block #A1 in step 502. The Node B transmits the second packet data block #A2 in step 503. The UE_A detects an error occurred in the received second packet data block #A2 and transmits the retransmission request message NAK#A2 for requesting retransmission of the second packet data block #A2, in step 504. The Node B transmits in step 505 the third packet data block #A3 succeeding the second packet data block #A2 before receiving the retransmission request message NAK#2 from the UE_A. The Node B receives the retransmission request message NAK#2 from the UE_A in step 506, and attempts to retransmit the second packet data block #A2 over the new designated DSCH different the channel used during initial transmission in step 573. Retransmitting the requested packet data is performed by the structure of 602 of FIG. 6. The reason that the retransmission-requested second packet data block #A2 is retransmitted over the retransmission channel DSCH after a slight delay from the point where the retransmission request message NAK#2 is received, is because other UEs also attempt retransmission through the DSCH. This is may cause a scheduling problem of the retransmission channel DSCH. During scheduling of the new channel DSCH, it should be noted that the maximum time limit that the retransmission-requesting UEs can wait should not be exceeded.

The UE_A successfully receives the second packet data block #A2 retransmitted from the Node B in step 574. Since the second packet data block #A2 is retransmitted over the new retransmission channel DSCH whose channel quality is higher than that of the dedicated channel DCH for initial transmission, the probability that the retransmitted packet data will have an error is decreased drastically.

The Node B transmits the fourth packet data block #A4 regardless of the received retransmission request message NAK#A2 in step 508, and repeats the above-stated process. As shown in FIG. 5A, the Node B continuously transmits the new packet data blocks at a constant data rate regardless of the channel environment, i.e., no matter how many packet data blocks have errors.

In the same manner, the UE_B also receives the new packet data blocks and the retransmitted packet data blocks. That is, the Node B transmits the first packet data block #B1 in step 531. The UE_B detects an error occurred in the received first packet data block #B1 and then transmits the retransmission request message NAK#B1 for requesting retransmission of the first packet data block #B1, in step 533, The Node B transmits the second and third packet data blocks #B2 and #B3 succeeding the first packet data block #B1 in steps 532 and 534, before receiving the retransmission request message NAK#B1 from the UE_B. After transmitting the retransmission request message NAK#B1, the UE_B receives the second and third packet data blocks #B2 and #B3 and decodes the received packet data blocks in steps 535 and 538.

The Node B receives the retransmission request message NAK#B1 from the UE_B in step 536, and attempts to retransmit the first packet data block #B1 through the new retransmission channel DSCH different from the channel used during initial transmission in response to the received retransmission request message NAK#B1, in step 571. The UE_B successfully receives the first packet data block #B1 retransmitted from the Node B in step 572. Since the first packet data block #B1 is also retransmitted over the new retransmission channel DSCH whose channel quality is higher than that of the dedicated channel DCH over which the initial packet data was transmitted, the probability that the retransmitted packet data will have an error is decreased drastically.

The reason that upon receipt of the retransmission request message NAK#B1 in step 536, the Node B can immediately retransmit the retransmission-requested packet data block through the new retransmission channel DSCH without delay in step 517 as shown in FIG. 5B, is because the retransmission is performed on the assumption that a buffer of the retransmission channel DSCH is empty.

The Node B transmits the fourth packet data block #B4 regardless of the received retransmission request message NAK#B1 in step 537. As shown in FIG. 5B, the Node B continuously transmits the new packet data blocks at a constant data rate regardless of the channel environment, i.e., no matter how many packet data blocks have errors, To sum up, the HARQ scheme according to an embodiment of the present invention is identical to the general HARQ scheme in the process where the UE sends the retransmission request message upon detecting an error from the initially transmitted packet data. However, the novel HARQ scheme is featured in that the retransmission-requested packet data is retransmitted over the new retransmission channel. At this point, all of the Node B's attempts to retransmit the failed packet data through one shared channel have the channel quality higher than that of the dedicated channel DCH, thereby making it possible to decrease the error rate during retransmission. In addition, since the Node B continuously transmits a sequence of packet data blocks through the dedicated channel DCH regardless of the received retransmission request message, and retransmits the failed packet data over the new channel DSCH, the UE can expect a constant throughput. Further, it is possible to drastically reduce the delay time due to the retransmission, by performing independent retransmission on the initially transmitted packet data.

As described above, the embodiment of the present invention retransmits the failed packet data through the retransmission channel having a higher channel quality, thereby making it possible to reduce the overall message transmission time. The reduction in the retransmission time facilitates decreasing the memory capacity required for implementation of the HARQ scheme. In addition, the embodiment can maintain a constant packet transfer rate regardless of instantaneous changes in the channel environment. That is, even though the channel environment of a certain UE is deteriorated abruptly causing an increase in the number of failed packet data blocks, the UE can expect a constant throughput since it has a structure for receiving the failed packet data blocks through a new channel different from the channel used for receiving the newly arriving packet data blocks. However, when the channel environments of many UEs become deteriorated at the same time causing an overload on the retransmission channel, the delay time may be unavoidably increased.

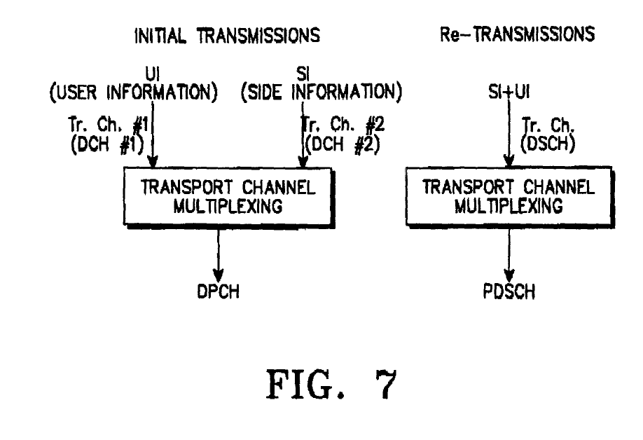

FIG. 7 illustrates a downlink channel structure for retransmitting the packet data in a HARQ scheme according to another embodiment of the present invention. Referring to FIG. 7, the Node B transmits RLC-PDU (Radio Link Control-Packet Data Unit) to the UE through 2 downlinks (or forward links) by way of example. The RLC-PDU, i.e., packet data, which is a transmission unit of the HARQ scheme has different transmission paths for initial transmission and retransmission due to the packet error. Further, FIG. 7 shows a mapping relationship between the transport channel and the physical channel, between the MAC layer and the physical layer. Here, the transmission unit RLC-PDU of the HARQ scheme including user information UI and side information SI. The user information UI is information generated in the upper layer, i.e., a user plane, and the side information SI includes control information data indicating a sequence number of the user information, a version number of the user information and an ACK/NAK signal, used when transmitting the user information. Therefore, the receiver processes the user information by analyzing the side information.

The user information and the side information are transmitted through different transport channels during initial transmission. As shown in FIG. 7 by way of example, the user information is transmitted over a transport channel DCH#1 while the side information is transmitted over a transport channel DCH#2. The user information and the side information are mapped with one dedicated physical channel DPCH through transport channel multiplexing. If the RLC-PDU initially transmitted over the DPCH has an error, the Node B retransmits the RLC-PDU using the same transport channel for both the user information and the side information unlike during the initial transmission. For example, as shown in FIG. 7, the user information and the side information are provided to a transport channel multiplexer through the same transport channel for which the downlink shared channel (DSCH) is used in the embodiment. The transport channel multiplexer maps the DSCH into one physical downlink shared channel (PDSCH) through transport channel multiplexing, thereby to retransmit the RLC-PDU failed during initial transmission. Although FIG. 7 shows an example where the Node B transmits the RLC-PDU to one UE, it will be understood by those skilled in the art that the Node B may create a plurality of transport channels in order to retransmit the RLC-PDUs to a plurality of UEs. Further, though not illustrated, the Node B transmits the UE information corresponding to the PDSCH information using the associated DPDCH in order to indicate to which UE the PDSCH for retransmitting the RLC-PDU corresponds. That is, the Node B transmits information indicating to which UE the user information UI and the side information SI, retransmitted over the PDSCH, of the failed packet data correspond, using the associated DPDCH, so that the corresponding UE can receive the RLC-PDU information retransmitted over the DSCH.

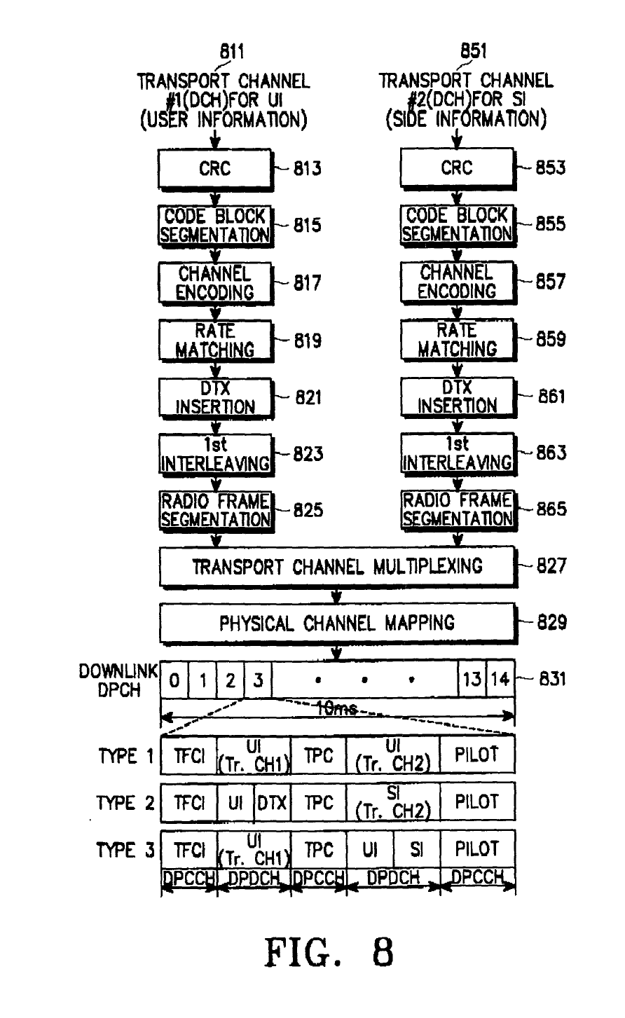

FIG. 8 illustrates a downlink channel structure for initial transmission of the packet data in a HARQ scheme according to another embodiment of the present invention. Referring to FIG. 8, user information UI (811) and side information SI (851) are transmitted through different transport channels. For example, the user information is transmitted over the transport channel DCH#1 and the side information is transmitted over the transport channel DCH#2. In addition, as shown in FIG. 8, CRC codes are added to the user information and the side information generated in the upper layer (Steps 813 and 853). The CRC is added in a unit of a transport block generated from the transport channel. After CRC adding, the Node B segments the CRC-added data into code blocks for an FEC code (Steps 815 and 855), and then performs channel encoding on the segmented data for channel transmission at a channel coding rage of 1, ½ or ⅓ (Steps 817 and 857). The Node B performs rate matching in consideration of a length and a spreading factor of a physical frame in order to actually transmit the channel-encoded data blocks to the physical layer (Steps 819 and 859). The rate matching process is equivalent to performing puncturing and repetition on the data blocks received from the upper layer. The Node B performs DTX (Discontinuous Transmission) insertion on the rate-matched data blocks in order to discontinue data transmission when the downlink has no data to transmit to the UE instantaneously (Steps 821 and 861). After the DTX insertion process, the Node B performs interleaving to prevent burst errors (Steps 823 and 863). After interleaving, the Node B segments the interleaved data blocks into radio frames and provides the final radio frames to a transport channel multiplexer (Steps 825 and 865).

The CRC adding process to the radio frame segmentation process are equally applied to both the user information and the side information, whereas the channel encoding part and the rate matching part may be differently applied to the user information and the side information, and the performance of the transport channels can be differently defined according to the channel coding and the rate matching. The user information and the side information are subjected to transport channel multiplexing (Step 827) and thereafter, subjected to physical channel mapping (Step 829). The physical channel mapping process is varied according to the physical channel used for transmission. In the embodiment, the Node B initially transmits the RLC-PDU over the DPCH physical channel using the DCH transport channel.

Now, a description will be made of a structure of a downlink DPCH channel 831 for initial transmission of the RLC-PDU. The downlink DPCH is comprised of 15 10 ms-slots having a slot number of 0 to 14, and each slot is comprised of DPCCHs (Dedicated Physical Control CHannels) and DPDCHs (Dedicated Physical Data CHannels). The DPCCH includes side information for the data transmitted over the DPDCH, and including TFCI (Transport Format Combination Indicator), TPC (Transmit Power Control) and PILOT. Further, the DPDCH is a part to which the user information is actually mapped. The user information and the side information transmitted to the physical layer through the different transport channels are mapped with the DPDCH part of the DPCH, and then, transmitted to the UE. The 3 types of the DPCH structure, shown in FIG. 8, are determined according to the information generated in the upper layer. The 3 types of the DPCH have fixed information formats. Actually, however, they are subjected to secondary interleaving after the transport channel multiplexing and the physical channel mapping, so that the user information and the side information may not be mapped with the DPCH in the fixed format.

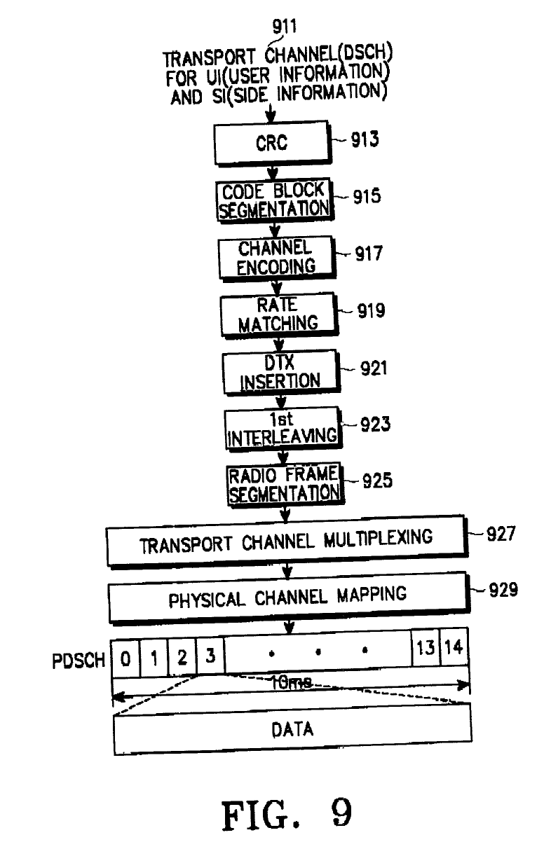

FIG. 9 illustrates a downlink channel structure for retransmission of the packet data in the HARQ scheme according to another embodiment of the present invention. If transmission errors have occurred in the user information and the side information transmitted over the 2 transport channels as described in FIG. 8, the Node B will retransmit the failed user information and side information. The failed user information and side information are retransmitted using the physical channel and the transport channel different from that used for initially transmitting the RLC-PDU. This is equivalent to using a separate transport channel for retransmitting only the failed RLC-PDUs. Herein, the DSCH is used for the separate transport channel for retransmitting the failed RLC-PDUs.

Referring to FIG. 9, the upper layer creates the initially transmitted user information and side information stored therein as user information and side information for retransmission (Step 911). The created user information and side information to be retransmitted are mapped with the PDSCH through the same transport channel DSCH before transmission. CRC codes are added to the created user information and side information to be retransmitted in a unit of the transport block generated from the transport channel (Step 913). After CRC adding, the Node B segments the CRC-added data into code blocks for an FEC code (Step 915), and performs channel encoding on the segmented code blocks for channel transmission at a channel coding rate of 1, ½ or ⅓ (Step 917). The Node B performs rate matching in consideration of a length and a spreading factor of a physical frame in order to actually transmit the channel-encoded data blocks to the physical layer (Step 919). The rate matching process is equivalent to performing puncturing and repetition on the data blocks received from the upper layer. The Node B performs DTX insertion on the rate-matched data blocks in order to discontinues data transmission when the downlink has no data to transmit to the UE instantaneously (Step 921). After the DTX insertion process, the Node B performs interleaving to prevent burst errors (Step 923). After interleaving, the Node B segments the interleaved data blocks into radio frames and provides the final radio frames to a transport channel multiplexer (Step 925). The user information and the side information are subjected to transport channel multiplexing (Step 927) and thereafter, subjected to physical channel mapping (Step 929). The physical channel mapping process is varied according to the physical channel used for the retransmission. In the case of FIG. 9, the Node B retransmits the failed RLC-PDU through the PDSCH physical channel using the DSCH transport channel. The downlink PDSCH for retransmitting the failed RLC-PDU is comprised of 15 10 ms-slots having a slot number of 0 to 14, wherein each slot is mapped with only the user information. The side information for controlling the user information transmitted over the PDSCH is always transmitted over the DPCH. Therefore, the PDSCH must be used together with the DPCH, which is called an “associated DPCH”.

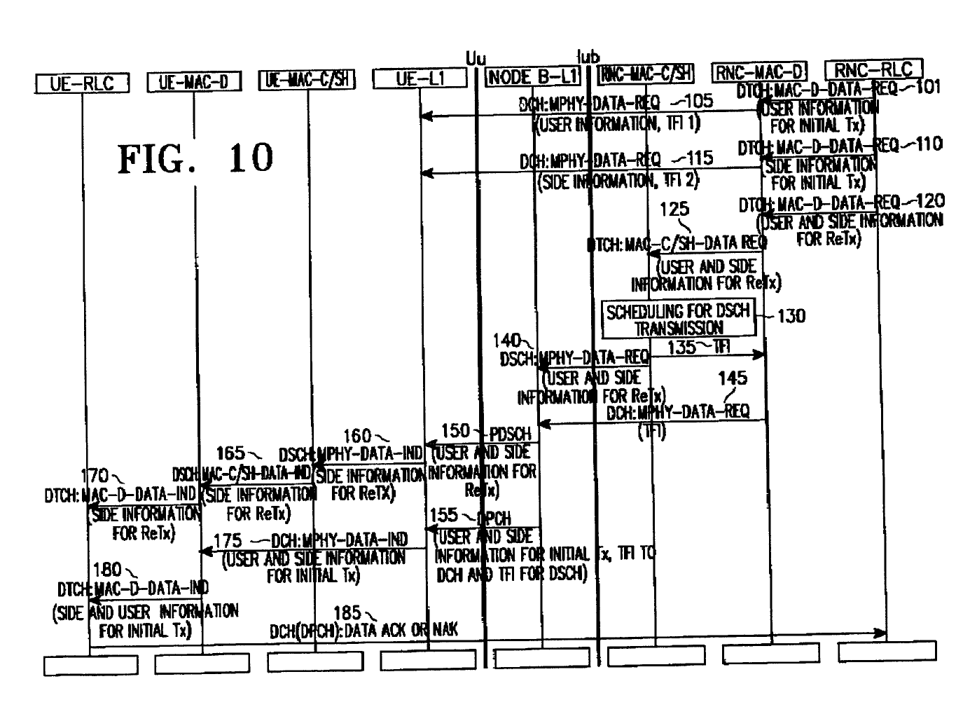

FIG. 10 illustrates a process for retransmitting downlink packet data in the HARQ scheme according to another embodiment of the present invention, wherein the HARQ scheme has the downlink channel structures shown in FIGS. 8 and 9. Now, with reference to FIG. 10, the initial transmission and the retransmission of the RLC-PDU in the HARQ scheme will be described referring to a call processing process between the respective layers.

Referring to FIG. 10, when user information UI and side information SI are generated, an upper layer RNC-RLC (Radio Network Controller-Radio Link Control) transmits a primitive for initial transmission of the generated user information to an RNC-MAC-D layer (Step 101), and transmits a primitive representative of the generated side information for controlling the user information to the RNC-MAC-D layer (Step 110). The primitives exchanged between the RNC-RLC layer and the RNC-MAC-D layer represent information on the logical channels.

Further, FIG. 10 shows a structure in which one RNC-RLC transmits the user information UI and the side information SI through 2 transport channels, which means that one RLC layer controls 2 transport channels. Though not illustrated in FIG. 10, in an alternative embodiment, 2 RLC layers may control 2 transport channels separately. That is, when the user information UI and the side information SI are transmitted through the different transport channels, the user information and the side information are generated in the independent RLC layers. Here, the side information is information annexed to the user information, for controlling the user information, and is created without a request from the upper layer, so that the RLC creating the user information should operate in sync with the RLC creating the side information. Therefore, when 2 RLC layers control 2 transport channels separately, the side information between the 2 RLC layers can be newly defined.

Here, the RNC, a Node B controller, serves as the base station controller (BSC) in the cdma200 system. Further, the MAC layer is divided into a MAC-D layer and a MAC-C/SH layer: the MAC-D layer controls the dedicated channel, while the MAC-C/SH layer controls the common or shared channel. Upon receipt of the user information and the side information from the RNC-RLC layer, the RNC-MAC-D layer transmits primitives representative of the received user information and side information to a Node B-L1 (Steps 105 and 115). Here, the Node B-L1, a physical layer of the Node B (or UTRAN), serves as the BTS (Base station Transceiver Subsystem) in the cdma2000 system. Further, since a dedicated traffic channel (DTCH) is used in steps 101 and 110, the RNC-MAC-C/SH layer is bypassed. The steps 101 to 115 show a signal flow for initial transmission of the RLC-PDU, and the succeeding steps 120 to 185 show a signal flow illustrating a process for retransmitting retransmission-requested RLC-PDU upon receipt of a retransmission request message for requesting retransmission of the initially transmitted RLC-PDU.

In the process of retransmitting the RLC-PDU, the RNC-RLC layer transmits a primitive representative of retransmission to the RNC-MAC-D layer (Step 120), when performing retransmission on the failed part of the RLC-PDU transmitted in the steps 101 and 110. As described above, regarding the information transmitted in step 120, the user information UI and the side information SI are transmitted using the same logical channel DTCH, and the RNC-MAC-D layer transmits the provided user information and side information to the RNC-MAC-C/SH layer. The MAC-C/SH layer in the RNC schedules transmission of the DSCH by analyzing the received primitive (Step 130). In the DSCH scheduling process, the RNC-MAC-C/SH layer transmits TFI (Transport Format Indicator) to the RNC-MAC-D layer in order to generate DCH for controlling the information to be transmitted over the DSCH (Step 135). Here, the TFI includes side information for the information to be transmitted over the DSCH. In addition, since the DCH is a dedicated channel, the RNC-MAC-D layer manages this function. After transmitting the TFI to the RNC-MAC-D layer, the RNC-MAC-C/SH layer transmits transmission information to the Node B-L1 according to the DSCH scheduling function (Step 140). At this point, the information transmitted to the Node B-L1 includes the initial transmission-failed RLC-PDUs. The RNC-MAC-D layer transmits a primitive to the Node B-L1 in order to transmit over the DCH the information constructed on the basis of the information provided according to the DSCH scheduling in step 130 (Step 145).

Upon receipt of the primitives, the Node B-L1 actually controls a physical channel between the Node B and the UE through a Uu interface which is an air interface between the Node B and the UE. The Node B-L1 transmits the user information and the side information of the failed RLC-PDUs to a corresponding UE-L1 through the PDSCH (Step 150), and transmits the user information and the side information of the RLC-PDUs initially transmitted according to the PDSCH transmission to the UE-L1 through the DPCH (Step 155). Here, the DPCH is an associated DPCH including the information for controlling the information transmitted over the DSCH, and transmits the side information received in step 145 by the Node B-L1 always using the associated DPCH when using the PDSCH. Upon receipt of the information from the Node B-L1 through the PDSCH and the DPCH, the UE-L1 transmits a primitive to a UE-MAC-C/SH layer in order to indicate that its physical layer has received the PDSCH (Step 160), and transmits a primitive to a UE-MAC-D layer in order to indicate reception of the DPCH (Step 175). That is, the UE-L1 transmits the failed RLC-PDUs to the MAC-C/SH layer in step 160, and transmits the initial RLC-PDUs to the MAC-D layer in step 175. Upon receipt of the primitive indicating reception of the PDSCH from the UE-L1, the UE-MAC-C/SH layer transmits the received information to the UE-MAC-D layer (Step 165), and the UE-MAC-D layer then reports the information received from the UE-MAC-C/SH layer to a UE-RLC layer (Steps 170 and 180).

The UE-RLC layer then transmits a response to the RLC-PDU received from the Node B-L1 to the RNC-RLC layer (Step 185). For example, if an error has occurred in the RLC-PDU received from the Node B-L1, the UE-RLC layer transmits a retransmission request NAK, and otherwise, transmits an ACK signal. Upon receipt of the retransmission request message NAK from the UE-RLC layer, the RNC-RLC layer analyzes the received retransmission request message NAK and the sequence number, and retransmits the RLC-PDU according to the analysis results in step 120. When retransmitting the RLC-PDU, the Node B (or transmitter) retransmits the sequence number and the version number of the RLC-PDU together with the user information.

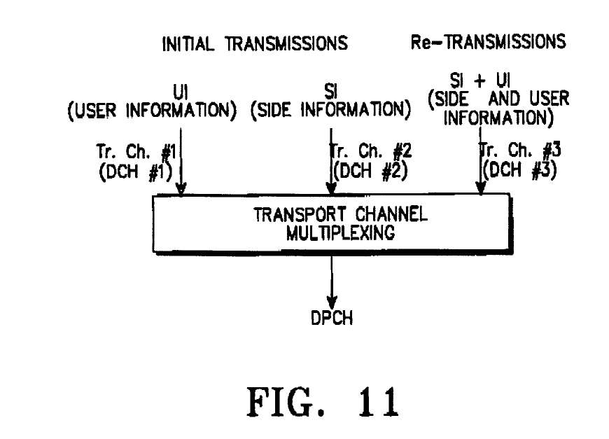

FIG. 11 illustrates an uplink channel structure for retransmission of the packet data in a HARQ scheme according to another embodiment of the present invention.

Referring to FIG. 11, in the uplink (or reverse link), the UE transmits the RLC-PDU using the DPCH. In a TDD (Time Division Duplex) mode, the UE can use DPCH, USCH (Uplink Shared CHannel), or DPCH+USCH. However, in the embodiment where only the FDD (Frequency Division Duplex) mode is applied, the UE uses only the DPCH. Similar to the downlink shown in FIG. 7, the UE uses the different transport channels DCH for initial transmission of the user information UI and the side information SI. For example, the user information is transmitted through the transport channel DCH#1 and the side information is transmitted through the transport channel DCH#2. The user information and the side information are mapped with one DPCH (Dedicated Physical CHannel) through the transport channel multiplexing. However, unlike the downlink, the uplink has no separate DSCH defined for retransmission, so that the uplink uses the same physical channel as that used for the initial transmission and uses a separate transport channel, e.g., DCH#3. Therefore, the uplink uses one physical channel DPCH and three transport channels DCH#1-DCH#3. Specifically, the uplink transmits the user information and the side information using the different transport channels during the initial transmission, and transmits the user information and the side information using the same transport channel during the retransmission.

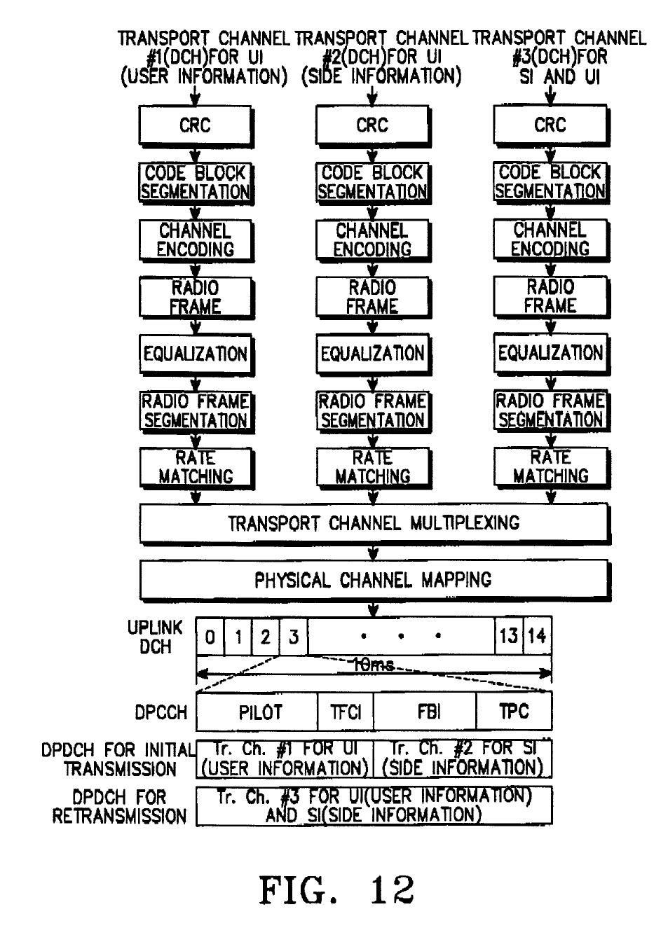

FIG. 12 illustrates an uplink channel structure for retransmission of the packet data in the HARQ scheme according to another embodiment of the present invention. The uplink is identical to the downlink in operation of the function blocks for processing the transport channels for initial transmission and retransmission of the RLC-PDU (see FIGS. 8 and 9). However, the uplink does not support the DTX insertion part of the downlink. This is because the uplink can transmit the DPCCH even though there exists no DPDCH, since the DPCCH and the DPDCH are physically generated. However, in the downlink, the DPDCH and the DPCCH are transmitted to the UE on a TDD basis, so that when there exists no information to be transmitted over the DPDCH, that part, is subjected to a DTX operation, obtaining the result of DTX insertion. Since the DPCCH and the DPDCH are comprised of different channels, they transmit different information. The DPCCH data including side information for controlling the DPDCH data, such as PILOT, TFCI, FBI (FeedBack Information) and TPC. The DPDCH has different transmission formats for one case where it is comprised of only the initially transmitted RLC-PDUs and for another case where it is comprised of only the retransmitted RLC-PDUs. The UE can set up a maximum of 7 DPDCHs, and the DPDCH for transmitting the initially transmitted RLC-PDUs and the DPDCH for retransmitting the failed RLC-PDUs are comprised of different channels. Therefore, the DPCCH transmits the information for controlling the information transmitted over the respective DPDCHs.

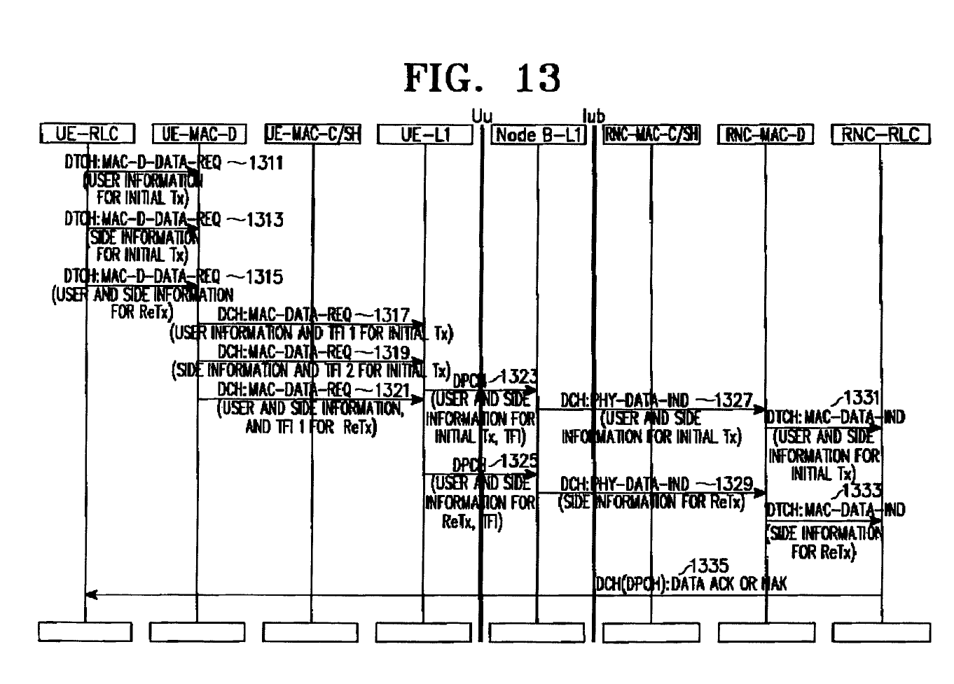

FIG. 13 illustrates a process for retransmitting uplink packet data in the HARQ scheme according to another embodiment of the present invention. Referring to FIG. 13, steps 1311, 1313 and 1315 indicate a process for transmitting user information and side information from the UE-RLC layer to the UE-MAC-D layer. Specifically, in the steps 1311 and 1313, the UE-RLC layer transmits primitives representative of the initially transmitted user information and side information to the UE-MAC-D layer, and in the step 1315, the UE-RLC layer transmits primitives representative of the retransmitted user information and side information to the UE-MAC-D layer using the same logical channel as that used for the initial transmission. Upon receipt of the primitives representative of the initially transmitted and retransmitted user information and side information, the UE-MAC-D layer transmits the primitives received from the UE-RLC layer to the UE-L1, i.e., a physical layer of the UE (Steps 1317, 1319 and 1321).

The UE-L1 then transmits the user information and the side information related to the RLC-PDU initially transmitted over the Uu interface, an air interface, to the Node B-L1 through the DPDCH (Step 1323), and transmits the user information and the side information related to the retransmitted RLC-PDU to the Node B-L1 through DPDCH (Step 1325).

As described above, it is possible to transmit the user information and the side information using either the different DPDCHs or the same DPDCH. When the different physical channels are used in transmitting the initially transmitted RLC-PDU and the retransmitted RLC-PDU, the spreading factor (SF) is usually set to 4. If the initial transmission and the retransmission are performed using one DPCH, three transport channels DCH#1, DCH#2 and DCH#3 are transmitted with one DPDCH. Although the channel is represented by DPCH in FIG. 13, the DPCH is actually comprised of the DPDCH and the DPCCH, and the DPCCH transmits the side information for the DPDCH data. Upon receipt of the DPCH, the physical layer of the Node B (Node B-L1) transmits primitives indicating reception of the DPCH to the RNC-MAC-D layer (Steps 1327 and 1329). As stated above, since the RNC-MAC-D layer manages control of the dedicated channel, the RNC-MAC-C/SH layer is bypassed. Upon receipt of the primitives indicating that the physical layer of the Node B has received the DPCH, the RNC-MAC-D layer informs the RNC-RLC layer that the information has been received from the UE (Steps 1331 and 1333). If an error has occurred in the received RLC-PDU, the RNC-RLC layer transmits a retransmission request message NAK to the UE (Step 1335). Upon receipt of the retransmission request message NAK, the UE retransmits the RLC-PDU matched with the sequence number of the RLC-PDU, included in the received retransmission request message NAK, together with its version number (Step 1315).

As shown in FIG. 13, one RLC layer transmits the user information UI and the side information SI through two transport channels, which means that one RLC layer controls two transport channels. In an alternative embodiment, two RLC layers can control two transport channels.

In sum, the novel HARQ scheme shown in FIGS. 7 to 13 transmits the downlink packet data using the dedicated physical channel during initial transmission, and upon detecting a retransmission request message for the initially transmitted packet data, retransmits the requested packet data through a separate retransmission channel, e.g., the physical downlink shared channel (PDSCH), thereby making it possible to increase a retransmission priority. Further, even in the uplink, the HARQ scheme separately designates the transport channels for the initial transmission and the retransmission thereby increasing priority of the retransmitted packet data.

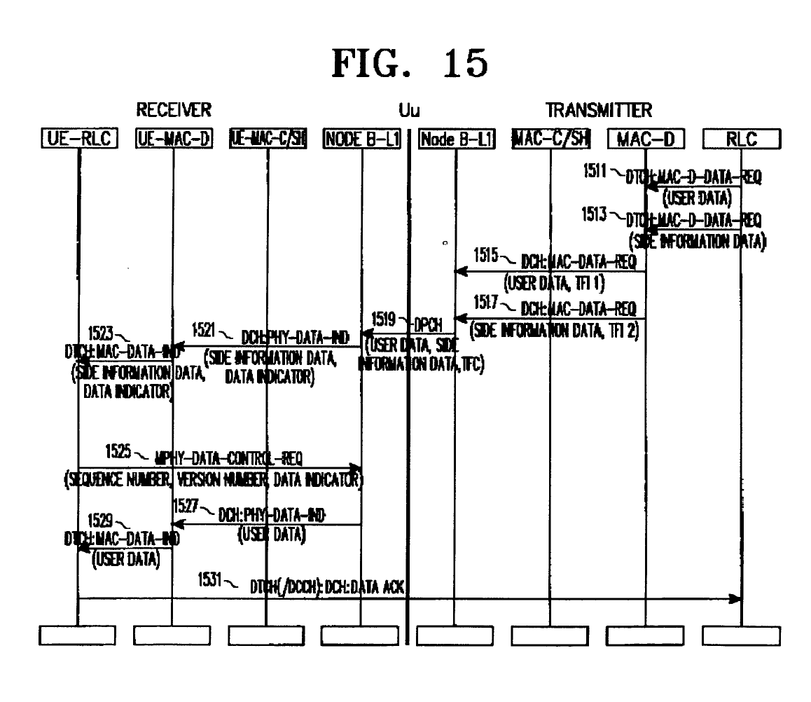

FIG. 15 illustrates multi-layered interfacing in a HARQ scheme according to another embodiment of the present invention. In particular, FIG. 15 illustrates a signal flow for providing a direct interfacing operation in which the side information is transmitted and processed according to a direct mutual operation between the RLC layer and the physical layer without an operation of the RRC layer. FIG. 15 shows a case where the side information SI and the user information UI are transmitted through two different transport channels, which are mapped with one physical channel DPCH. When user information UI and side information SI are generated, the upper layer RLC transmits a primitive for the generated user information UI to a MAC-D (Medium Access Control-Dedicated channel) layer (Step 1511), and transmits a primitive for the side information for controlling the user information to the MAC-D layer (Step 1513). Here, the “primitive” exchanged between the RLC layer and the MAC-D layer indicates information on the logical channel.

FIG. 15 illustrates a structure in which one RLC layer transmits the side information SI and the user information UI through two transport channels. This means that one RLC layer controls 2 transport channels. Though not illustrated in FIG. 15, in an alternative embodiment, two RLC layers can control two transport channels. Upon receipt of the user information and the side information from the RLC layer, the MAC-D layer transmits primitives for the received user information and side information to the Node B-L1 (Steps 1515 and 1517). Since a dedicated traffic channel (DTCH) is used in steps 1511 and 1513, the MAC-C/SH layer is bypassed.

Upon receipt of the primitives for the user information and the side information, the Node B-L1 actually controls a physical channel between the Node B-L1 and the UE through a Uu interface which is an air interface between the Node B-L1 and the UE (Step 1519). Here, a dedicated physical channel (DPCH) is used for the physical channel, and the DPCH is comprised of a dedicated physical control channel (DPCCH) and a dedicated physical data channel (DPDCH). The DPDCH is a physical channel for transmitting the user information and the side information, while the DPCCH is a physical channel for transmitting side information used for transmitting data through the DPDCH channel. Upon receipt of the DPCH through the physical layer after establishment of the physical channel between the Node B-L1 and the UE, the UE transmits to the MAC-D layer a primitive indicating that its physical layer has received the DPCH (Step 1521). That is, the UE, by using the primitives, transmits to the MAC-D layer the side information SI used for storing the received user information UI in the physical layer and controlling the user information UI. The side information transmitted to the MAC-D layer includes a sequence number and a version number of RLC-PDU stored in the UE's physical layer (LYE-L1). Thereafter, the MAC-D layer transmits a primitive representative of the received side information SI to the UE's RLC layer (Step 1523). Here, the primitive transmitted from the MAC-D layer to the RLC layer is actually created and added in the Node B's RLC layer Node B-L1, so that the side information added in the Node B-L1 is analyzed in the UE's RLC layer. The side information analyzed in the LYE's RLC layer is information actually used in the physical layer, and is used for correct decoding of the RLC-PDU stored in the physical layer.

After analyzing the side information received from the MAC-D layer, the RLC layer transmits to the UE's physical layer UE-L1 a primitive MPHY-DATA-Control-REQ including a sequence number, a version number and a data indicator for indicating that the user information is stored in the physical layer (Step 1525). By directly transmitting the primitive from the RLC layer to the UE-L1, it is possible to reduce the delay time caused by the conventional process for transmitting the analyzed side information from the RLC layer to the RRC layer and then transmitting again the information from the RRC layer to the physical layer, and also reduce the system load caused when the RRC layer is enabled to transmit the side information to the physical layer each time the physical layer receives the user information.

Thereafter, upon receipt of the primitive from the RLC layer, the UE-L1 processes the RLC-PDU presently stored in the LYE-L1 by analyzing the received primitive, and then transmits the processed RLC-PDU to the MAC-D layer (Step 1527). At this point, the LYE-L1 transmits only the RLC-PDU corresponding to the pure user information excepting the side information. Upon receipt of the user information from the physical layer, the MAC-D layer transmits the received user information to the RLC layer (Step 1529). The RLC layer then generates an ACK signal if the user information received from the MAC-D layer is determined as error-free RLC-PDU. Otherwise, if the user information received from the MAC-D layer is determined as failed RLC-PDU, the RLC layer generates a retransmission request message NAK. The generated ACK or NAK signal is transmitted to the Node B's RLC layer (Step 1531). If the Node B's RLC layer receives the NAK signal, it performs the retransmission process on the failed RLC-PDU.

For the primitive MPHY-DATA-Control-REQ mentioned in step 1525, the details can be defined as follows:

Primitive is defined as follows:

TABLE 1
Primitive between RLC and MAC layers

| | Parameters | | | |
|---|---|---|---|---|
| Generic Name | Req. | Ind. | Resp. | Conf. |
| RLC-DATA- | Sequence Number, Version | Not | Not | Not |
| CONTROL | Number, Data Indicator | defined | defined | defined |

RLC-DATA-CONTROL-Req
RLC-DATA-CONTROL-Req is used by the RLC layer to indicate MAC layer side information of RLC-PDUs that have been transmitted in HARQ type II/III modes.

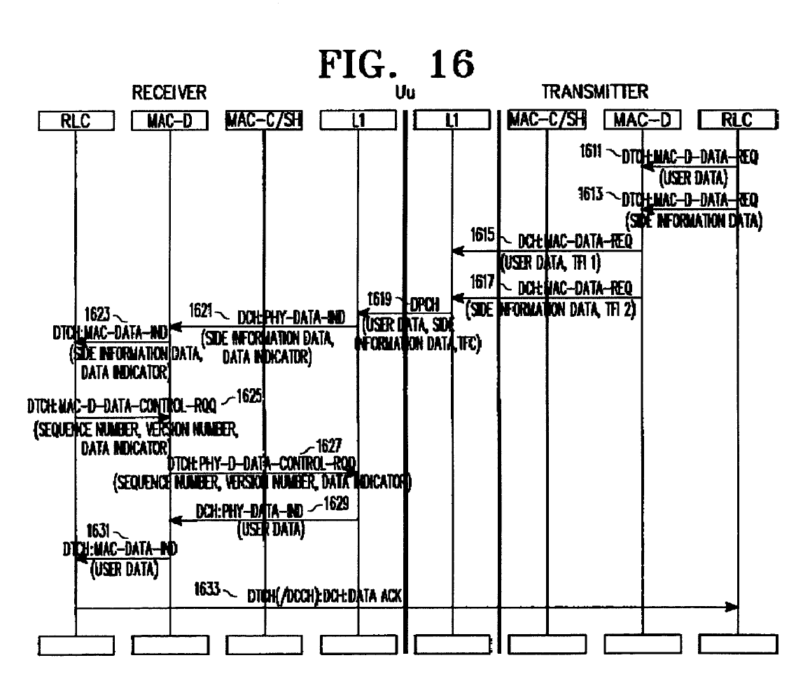

FIG. 16 illustrates multi-layered interfacing in the HARQ scheme according another embodiment of the present invention. In particular, FIG. 16 illustrates an interfacing operation in which the MAC layer is used for interfacing between the RLC layer and the physical layer, so that the side information is transmitted from the RLC layer to the MAC layer and then transmitted from the MAC layer to the physical layer. Steps 1611 to 1623 of FIG. 16 are equivalent to the steps 1511 to 1523 of FIG. 157 so the detailed description will not be provided.

After analyzing the side information received from the MAC-D layer in step 1623, the RLC layer transmits to the MAC-D layer a primitive MAC-D-DATA-CONTROL-REQ including a sequence number, a version number and a data indicator for indicating that the user information is stored in the physical layer (Step 1625). By transmitting the primitive MAC-D-DATA-CONTROL-REQ from the RLC layer to the MAC-D layer, it is possible to reduce the delay time caused by the conventional process for transmitting the analyzed side information from the RLC layer to the RRC layer and then transmitting again the information from the RRC layer to the physical layer, and also reduce the system load caused when the RRC layer is enabled to transmit the side information to the physical layer each time the physical layer receives the user information. In this embodiment, the RLC layer transmits the primitive MAC-D-DATA-CONTROL-REQ representative of the sequence number and the version number of the RLC-PDU currently stored in the physical layer to the MAC-D layer using the DTCH. Upon receipt of the primitive MAC-D-DATA-CONTROL-REQ from the RLC layer, the MAC-D layer transmits a parameter PHY-DATA-CONTROL-REQ to the physical layer using the transport channel (Step 1627). The parameter PHY-DATA-CONTROL-REQ also includes the same information as that included in the parameter MAC-D-DATA-CONTROL-REQ, i.e., includes the sequence number, the version number and the data indicator indicating that the user information is stored in the physical layer. Steps 1629 to 1633 succeeding the step 1627 are also equivalent to the steps 1527 to 1531 of FIG. 15, so the detailed description will not be provided.

For the primitives MAC-D-DATA-CONTROL-REQ and PHY-DATA-CONTROL-REQ, mentioned in step 1525, the details can be defined as follows:

TABLE 2
Primitives between MAC layer and Physical Layer

| | Parameters | | | |
|---|---|---|---|---|
| Generic Name | Request | Indication | Response | Confirm |
| PHY-DATA- | Sequence Number, | Not | Not | Not |
| CONTROL | Version Number, | defined | defined | defined |
| | Data Indicator | | | |

PHY-DATA-CONTROL-Req:
MAC-DATA-CONTROL-Req is used by MAC layer to indicate Physical layer side information of RLC-PDUs that have been transmitted in HARQ type II/III modes.

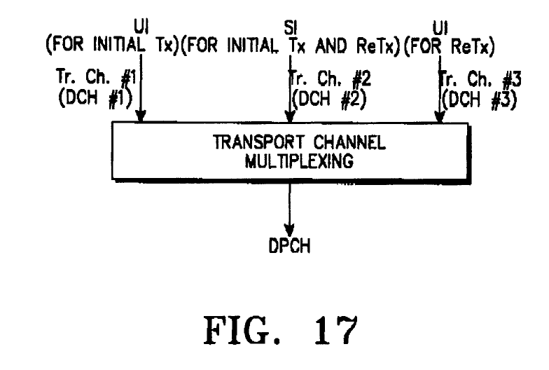

FIG. 17 illustrates a downlink channel structure for retransmission of packet data in a HARQ scheme according to another embodiment of the present invention. In case of FIG. 17, the Node B (or UTRAN) transmits RLC-PDU to the UE through the downlink (or forward link), wherein the Node B transmits the RLC-PDU to the UE using one physical channel. In FIG. 17, the RLC-PDU, a transmission unit of the HARQ scheme, has different transmission paths for initial transmission and retransmission due to the transmission error. Further, FIG. 17 shows a mapping relationship between the transport channel and the physical channel, between the MAC layer and the physical layer.

The user information and the side information are transmitted through the different transport channels during initial transmission. In an example shown in FIG. 17, the user information is transmitted through the transport channel DCH#1, while the side information is transmitted through the transport channel DCH#2. The user information and the side information are mapped with one physical channel DPCH (Dedicated Physical CHannel) through transport channel multiplexing. If an error has occurred in the RLC-PDU initially transmitted through the DPCH, the initially transmitted RLC-PDU is retransmitted.

Preferably, the retransmitted RLC-PDU should have a higher transmission guarantee (or success) rate compared with the initially transmitted RLC-PDU. To this end, a transport channel different from that used during initial transmission should be used to maintain the high transmission quality of the channels, thereby guaranteeing the transmission quality and the higher transmission priority compared with the initially transmitted RLC-PDU. Therefore, the transport channel for transmitting the retransmitted RLC-PDU is different from the transport channel used during the initial transmission. In addition, since the side information SI is used for controlling the user information UI, it must be superior to the user information in the transmission quality. Therefore, the side information SI must be assigned to the transport channel different from the transport channel over which the user information UI was transmitted. Accordingly, as shown in FIG. 17, during retransmission of the RLC-PDU, the side information SI is assigned to the same channel as the transport channel over which the side information SI was transmitted during the initial transmission. Since the side information SI has a higher transmission priority compared with the user information, the side information SI can use the same transport channel during both the initial transmission and the retransmission. FIG. 17 shows how to process the transport channels in the case where the transport channel DCH#2 has a first priority and the transport channels DCH#1 and DCH#3 have a second priority. Although FIG. 17 shows a case where the packet data is transmitted to one UE, it is also possible to create a plurality of transport channels for retransmitting the packet data to a plurality of UEs.

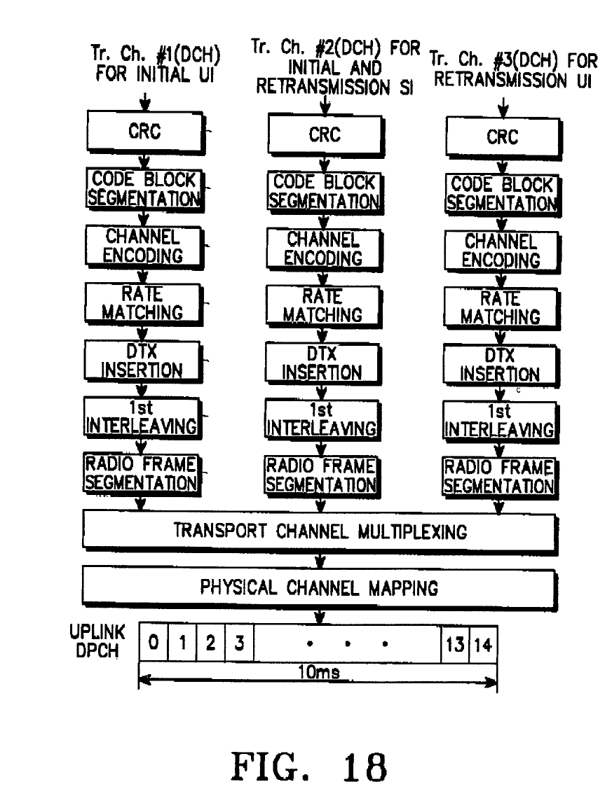

FIG. 18 illustrates a downlink channel structure for initial transmission and retransmission of the packet data in a HARQ scheme according to another embodiment of the present invention. Referring to FIG. 18, user information UI and side information SI are transmitted through different transport channels. For example, the user information is transmitted over the transport channel DCH#1 and the side information is transmitted over the transport channel DCH#2. The process for mapping the user information and the side information during the initial transmission is the same as described in FIG. 8, so the description will be omitted.

However, when errors have occurred in the user information and the side information transmitted through the 2 separate transport channels, the failed user information and side information are retransmitted. The user information is retransmitted through the physical channel and the transport channel different from the transport channel over which the RLC-PDU was initially transmitted, thus having the effect of using the separate retransmission channel for the failed RLC-PDUs. Herein, the DCH is used for the transport channel exclusively used for the failed RLC-PDUs. Further, for retransmission of the side information, the physical channel and the same transport channel as that used for initial transmission of the RLC-PDU are used.

As illustrated in FIG. 18, the upper layer creates the initially transmitted user information and side information stored therein as user information and side information for retransmission. The side information to be retransmitted is transmitted through the same transport channel DCH#2 as that used during the initial transmission, while the user information to be retransmitted is transmitted through the new transport channel DCH#3. The side information and the user information are then mapped with the DPCH after transport channel multiplexing. The channel mapping process for the retransmitted user information and side information, including the CRC adding and error correction process is performed in the same manner as described in FIG. 8, so that the detailed description will not be provided.

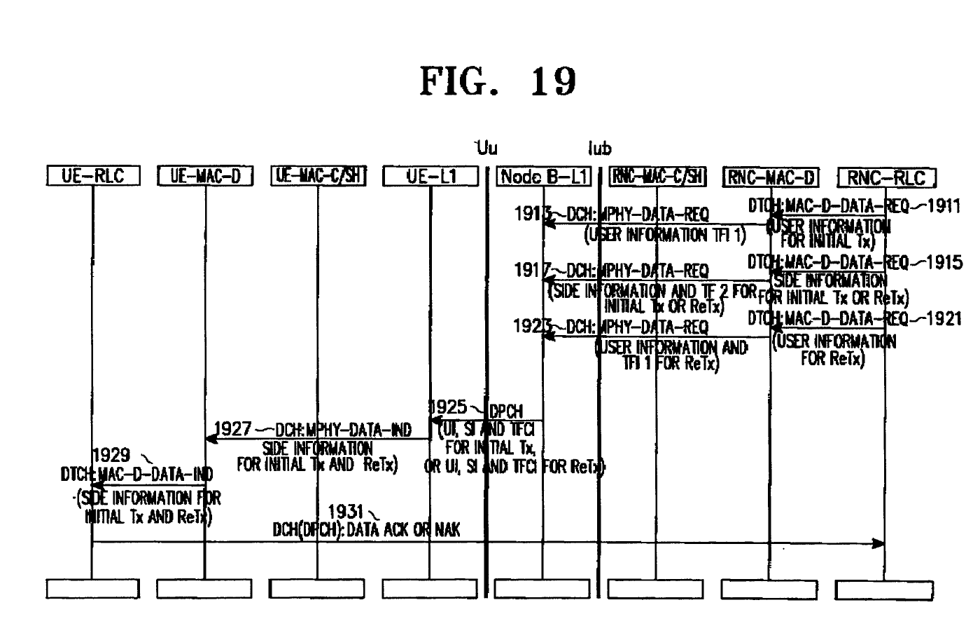

FIG. 19 illustrates a process for retransmitting the downlink packet data in a HARQ scheme according to another embodiment of the present invention. The retransmission process will be described with reference to the downlink channel structure described in FIGS. 17 and 18. Now, with reference to FIG. 19, the initial transmission process and the retransmission process of the RLC-PDU in the HARQ scheme will be described referring to a call processing process between the respective layers.

Referring to FIG. 19, when user information UI and side information SI are generated, an upper layer RNC-RLC (Radio Network Controller-Radio Link Control) transmits a primitive for initial transmission of the generated user information to an RNC-MAC-D layer (Step 1911), and transmits a primitive representative of the generated side information for controlling the user information to the RNC-MAC-D layer (Step 1915). The primitives exchanged between the RNC-RLC layer and the RNC-MAC-D layer represent information on the logical channels.

Further, FIG. 19 shows a structure in which one RNC-RLC transmits the user information UI and the side information SI through 2 separate transport channels, which means that one RLC layer controls 2 transport channels. Though not illustrated in FIG. 19, in an alternative embodiment, 2 RLC layers may control 2 transport channels separately. Upon receipt of the user information and the side information from the RNC-RLC layer, the RNC-MAC-D layer transmits primitives representative of the received user information and side information to a Node B-L1 (Steps 1913 and 1917). Since a dedicated traffic channel (DTCH) is used in steps 1911 and 1915, the RNC-MAC-C/SH layer is bypassed. The steps 1911 to 1917 show a signal flow for initial transmission of the RLC-PDU.

In the process of retransmitting the RLC-PDU, the RNC-RLC layer transmits primitives to the RNC-MAC-D layer (Steps 1915 and 1921), when performing retransmission on the failed part of the RLC-PDU transmitted in the steps 1911 and 1915. The side information SI transmitted in step 1915 is transmitted to the RNC-MAC-D layer using the same logical channel as that used during the initial transmission, while the user information UI transmitted in step 1921 is transmitted to the RNC-MAC-D layer using the logical channel different from that used during the initial transmission. The side information SI and the user information UI are then transmitted from the RNC-MAC-D layer to the Node B-L1 (Steps 1917 and 1923). Thereafter, the Node B-L1 transmits various information to the UE-L1 through the Uu interface, an air interface (Step 1925). The information transmitted through the Uu interface may include the user information and the side information of the initially transmitted RLC-PDUs, or the user information and the side information of the retransmitted RLC-PDUs. Upon receipt of the user information and the side information from the Node B-L1, the UE-L1 stores the user information UI therein and transmits only the side information SI to the UE-MAC-D layer (Step 1927). The primitive transmitted in the step 1927 is used to inform the UE-MAC-D layer that the UE-L1 has received the DPCH.

The UE-MAC-D layer provides the side information SI received from the UE-L1 to the UE-RLC layer (Step 1929), and the UE-RLC layer then transmits a response to the RLC-PDU received at the UE to the RNC-RLC layer (Step 1931). The “response” becomes a retransmission request message NAK when an error has occurred in the RLC-PDU received at the UE, and becomes an ACK signal when the no error has occurred in the received RLC-PDU. Upon receipt of the retransmission request message NAK, the RNC-RLC layer analyzes the received retransmission request message NAK and the sequence number, and retransmits the RLC-PDU according to the analysis results in steps 1915 and 1921. When retransmitting the RLC-PDU, the Node B (or transmitter) retransmits the sequence number and the version number of the RLC-PDU together with the user information.

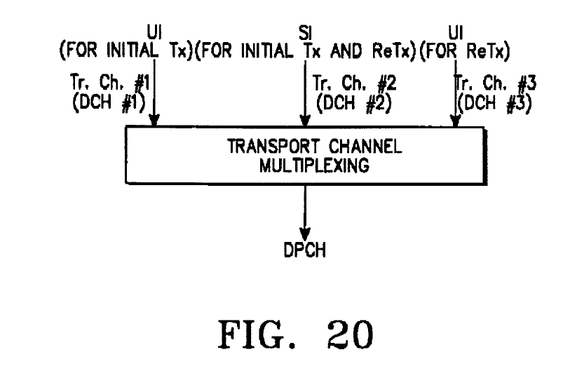

FIG. 20 illustrates an uplink channel structure for retransmission of the packet data in a HARQ scheme according to another embodiment of the present invention. Referring to FIG. 20, in the uplink (or reverse link), the UE transmits the RLC-PDU using the DPCH. In a TDD mode, the UE can use DPCH, USCH (Uplink Shared CHannel), or DPCH+USCH. However, in the embodiment where only the FDD mode is applied, the UE uses only the DPCH. Similarly to the downlink shown in FIG. 17, the UE uses the different transport channels DCH for initial transmission of the user information UI and the side information SI. For example, the user information is transmitted through the transport channel DCH#1 and the side information is transmitted through the transport channel DCH#2. The user information and the side information are mapped with one DPCH (Dedicated Physical CHannel) through the transport channel multiplexing. Further, for retransmission, the uplink uses the same physical channel as that used for the initial transmission. In particular, to differentiate the transport channels, the side information SI uses the same transport channel DCH#2 as that used for the initial transmission, while the user information UI uses a transport channel, e.g., DCH#3 different from that used for the initial transmission. Therefore, the uplink uses one physical channel DPCH and three transport channels DCH#1-DCH#3. Specifically, the uplink transmits the user information and the side information using the different transport channels during the initial transmission. However, during retransmission, the uplink transmits the side information using the transport channel over which the side information was transmitted during the initial transmission, and transmits the user information using the transport channel different from the transport channel over which the user information was transmitted during the initial transmission.

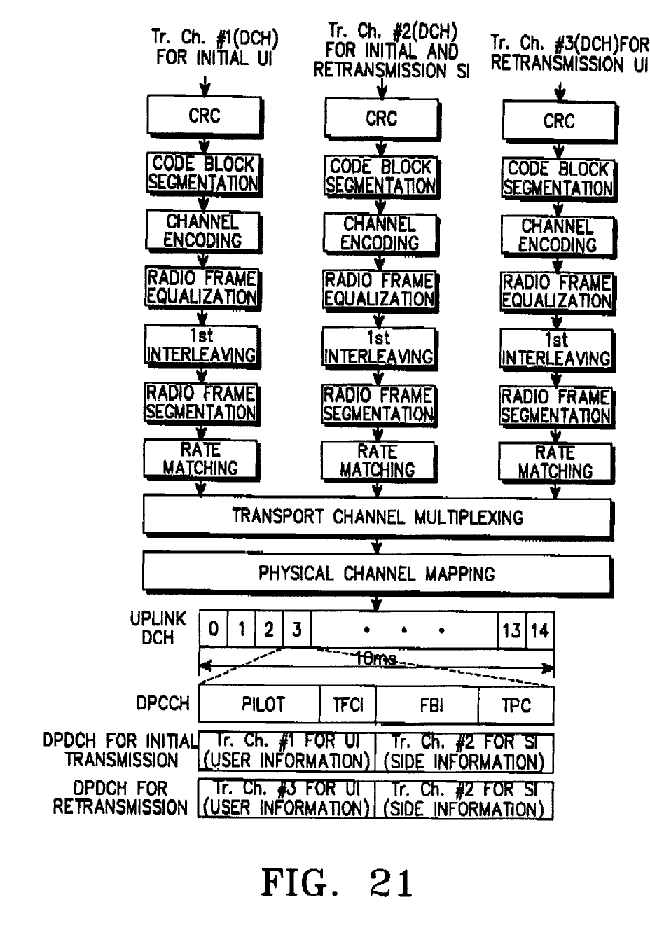

FIG. 21 illustrates an uplink channel structure for retransmission of the packet data in a HARQ scheme according to another embodiment of the present invention. The transport channel-related function blocks of FIG. 21, i.e., the CRC adding, segmentation and interleaving blocks are identical to the corresponding blocks shown in FIG. 18, so the detailed description will be omitted. However, the uplink does not support the DTX insertion part of the downlink. This is because the uplink can transmit the DPCCH to the Node B even though there exists no DPDCH, since the DPCCH and the DPDCH are physically generated. However, in the downlink, the DPDCH and the DPCCH are transmitted to the UE on a TDD basis, so that when there exists no information to be transmitted over the DPDCH, that part is subjected to a DTX operation, obtaining the result of DTX insertion. Since the DPCCH and the DPDCH are comprised of different channels, they transmit different information. The DPCCH is comprised of information for controlling the DPDCH, such as PILOT, TFCI, FBI (FeedBack Information) and TPC. The DPDCH has different transmission formats for one case where it is comprised of only the initially transmitted RLC-PDUs and for another case where it is comprised of only the retransmitted RLC-PDUs. The UE can set up a maximum of 7 DPDCHs, and the DPDCH for transmitting the initially transmitted RLC-PDUs and the DPDCH for retransmitting the failed RLC-PDUs are comprised of different channels. However, the side information SI is transmitted over the same channel, for both the initial transmission and the retransmission.

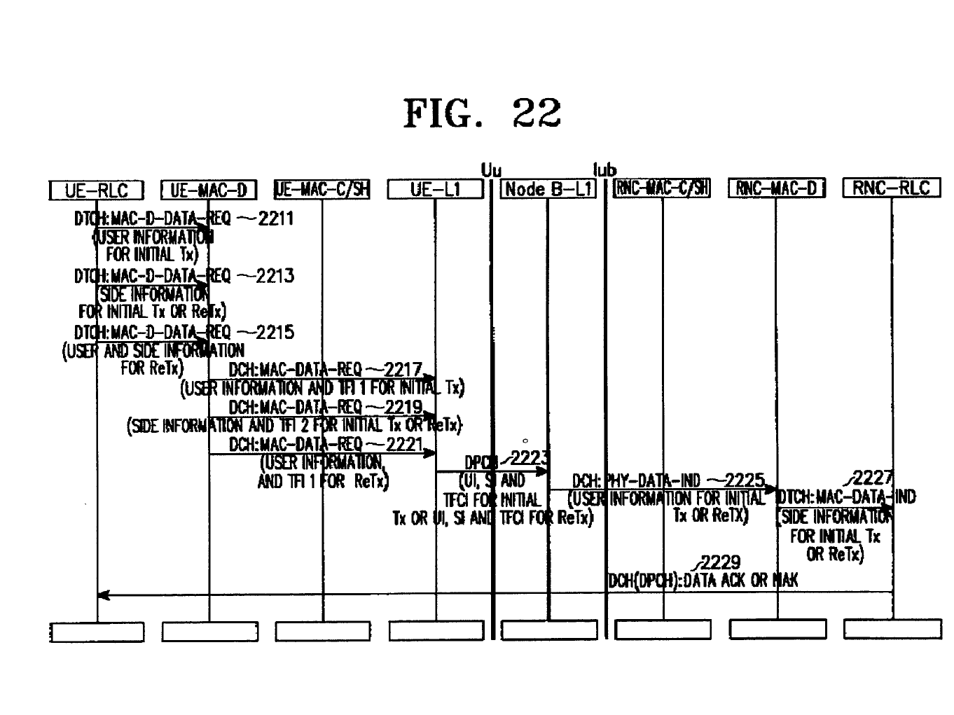

FIG. 22 illustrates a process for retransmitting uplink packet data in the HARQ scheme according to another embodiment of the present invention. Referring to FIG. 22, steps 2211, 2213 and 2215 indicate a process for transmitting primitives representative of user information and side information from the UE-RLC layer to the UE-MAC-D layer. Specifically, the UE-RLC layer transmits the initially transmitted user information to the UE-MAC-D layer in the step 2211, and transmits the initially transmitted side information and the retransmitted side information to the UE-MAC-D layer in the step 2213. Further, in step 2215, the UE-RLC layer transmits the retransmitted user information to the UE-MAC-D layer. Upon receipt of the primitives from the UE-RLC layer, the UE-MAC-D layer transmits primitives representative of information on the received primitives to the UE-L1 (Steps 2217, 2219 and 2221). To be concrete, the step 2217 shows a transport channel over which the user information of the initially transmitted RLC-PDU is transmitted, the step 2219 shows a transport channel over which the side information of the initially transmitted and retransmitted RLC-PDUs are transmitted, and the step 2221 shows a transport channel over which the user information of the retransmitted RLC-PDU is transmitted.

The UE's physical layer UE-L1 then transmits the user information and the side information related to the initially transmitted RLC-PDU and the user information and the side information related to the retransmitted RLC-PDU to the Node B's physical layer Node B-L1 through the DPCH (Step 2223). In step 2223, the Uu interface, an air interface, is used between the UE-L1 and the Node B-L1. Upon receipt of the DPCH from the UE-L1, the Node B-L1 transmits a primitive indicating receipt of the DPCH to the RNC-MAC-D layer (Step 2225). In other words, the Node B-L1 stores the received intact user information therein and transmits only the side information to the upper layer, i.e., the RNC-MAC-D layer. As stated above, since the RNC-MAC-D layer manages control of the dedicated channel, the RNC-MAC-C/SH layer is bypassed. Upon receipt of the primitive indicating receipt of the DPCH from the Node B-L1, the RNC-MAC-D layer informs the RNC-RLC layer that the information has been received from the UE (Step 2227). If an error has occurred in the received RLC-PDU, the RNC-RLC layer transmits a retransmission request message NAK to the UE using a primitive (Step 2229). Upon receipt of the retransmission request message NAK, the UE retransmits the RLC-PDU matched with the sequence number of the RLC-PDU, included in the received retransmission request message NAK, together with its version number (Steps 2213 and 2215).

As described above, one RLC layer transmits the user information UI and the side information SI through two transport channels, which means that one RLC layer controls two transport channels. In an alternative embodiment, however, two RLC layer can control two transport channels.

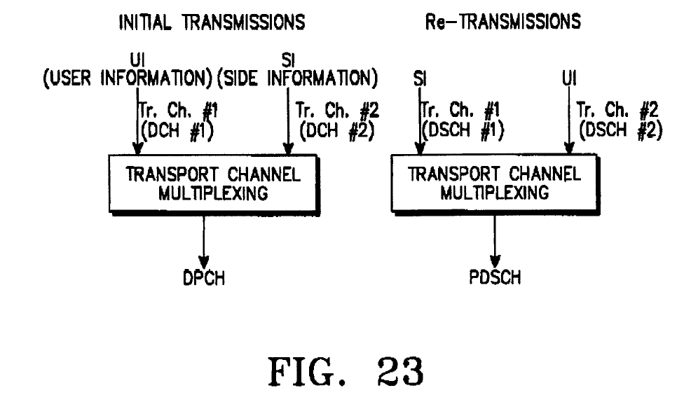

FIG. 23 illustrates a downlink channel structure for retransmission of the packet data in a HARQ according to another embodiment of the present invention. In the case of FIG. 23, the Node B transmits RLC-PDU to the UE through the downlink (or forward link), wherein the Node B transmits the RLC-PDU to the UE using two physical channels. In FIG. 23, the RLC-PDU, a transmission unit of the HARQ scheme, has different transmission paths for initial transmission and retransmission due to the transmission error. Further, FIG. 23 shows a mapping relationship between the transport channel and the physical channel, between the MAC layer and the physical layer.

The user information and the side information are transmitted through the different transport channels during initial transmission. In an example shown in FIG. 23, the user information is transmitted through the transport channel DCH#1, while the side information is transmitted through the transport channel DCH#2. The user information and the side information are mapped with one physical channel DPCH (Dedicated Physical CHannel) through transport channel multiplexing. If an error has occurred in the RLC-PDU initially transmitted through the DPCH, the initially transmitted RLC-PDU is retransmitted. In the retransmission process, the side information is transmitted over a transport channel DSCH#1 and the user information is transmitted over a transport channel DSCH#2. The user information and the side information are provided to a transport channel multiplexer through the DSCHs (Downlink Shared CHannels), and the transport channel multiplexer then maps the DSCHs with one physical channel PDSCH (Physical Downlink Shared Channel) through transport channel multiplexing, thereby retransmitting the failed initial RLC-PDU. Although FIG. 23 shows a case where the packet data is transmitted to one UE, it is also possible to create a plurality of transport channels for retransmitting the packet data to a plurality of UEs. Further, though not illustrated, the Node B transmits the UE information corresponding to the PDSCH information using the associated DPDCH in order to indicate to which UE the PDSCH for retransmitting the RLC-PDU corresponds. That is, the Node B transmits information indicating to which UE the user information UI and the side information SI, retransmitted over the PDSCH, of the failed packet data correspond, using the associated DPDCH, so that the corresponding UE can receive the RLC-PDU information retransmitted over the DSCH.

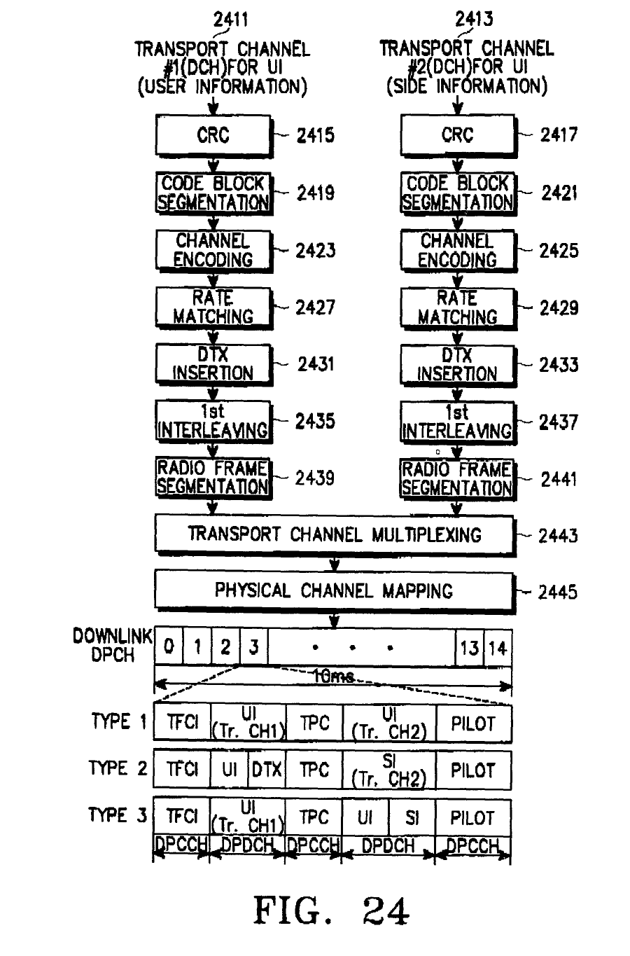

FIG. 24 illustrates a downlink channel structure for initial transmission of the packet data in a HARQ scheme according to another embodiment of the present invention. Referring to FIG. 24, user information UI (2411) and side information SI (2413) are transmitted through different transport channels. For example, the user information is transmitted over the transport channel DCH#1 and the side information is transmitted over the transport channel DCH#2. As shown in FIG. 24, CRC codes are added to the user information and the side information generated in the upper layer (Steps 2415 and 2417). The CRC is added in a unit of a transport block generated from the transport channel. After CRC adding, the Node B segments the CRC-added data into code blocks for an FEC code (Steps 2419 and 2421), and then performs channel encoding on the segmented data for channel transmission at a channel coding rage of 1, ½ or ⅓ (Steps 2423 and 2425). The Node B performs rate matching in consideration of a length and a spreading factor of a physical frame in order to actually transmit the channel-encoded data blocks to the physical layer (Steps 2427 and 2429). The rate matching process is equivalent to performing puncturing and repetition on the data blocks received from the upper layer. The Node B performs DTX (Discontinuous Transmission) insertion on the rate-matched data blocks in order to discontinue data transmission when the downlink has no data to transmit to the UE instantaneously (Steps 2431 and 2433). After the DTX insertion process, the Node B performs interleaving to prevent burst errors (Steps 2435 and 2437). After interleaving, the Node B segments the interleaved data blocks into radio frames and provides the final radio frames to a transport channel multiplexer (Steps 2439 and 2441).

The CRC adding process to the radio frame segmentation process are equally applied to both the user information and the side information, whereas the channel encoding part and the rate matching part may be differently applied to the user information and the side information, and the performance of the transport channels can be differently defined according to the channel coding and the rate matching. The user information and the side information are subjected to transport channel multiplexing (Step 2443) and thereafter, subjected to physical channel mapping (Step 2445). The physical channel mapping process is varied according to the physical channel used for transmission. In FIG. 24, the Node B initially transmits the RLC-PDU over the DPCH physical channel using the DCH transport channel.

Now, a description will be made of a structure of the downlink DPCH channel for initial transmission of the RLC-PDU. The downlink DPCH is comprised of 15 10 ms-slots having a slot number of 0 to 14, and each slot is comprised of DPCCHs (Dedicated Physical Control CHannels) and DPDCHs (Dedicated Physical Data Channels). The DPCCH includes side information for the data transmitted over the DPDCH, and is comprised of TFCI (Transport Format Combination Indicator), TPC (Transmit Power Control) and PILOT. Further, the DPDCH is a part to which the user information is actually mapped. The user information and the side information transmitted to the physical layer through the different transport channels are mapped with the DPDCH part of the DPCH, and then, transmitted to the UE. The 3 types of the DPCH structure, shown in FIG. 24, are determined according to the information generated in the upper layer. The 3 types of the DPCH have fixed information formats. Actually, however, they are subjected to secondary interleaving after the transport channel multiplexing and the physical channel mapping, so that the user information and the side information may not be mapped with the DPCH in the fixed format.

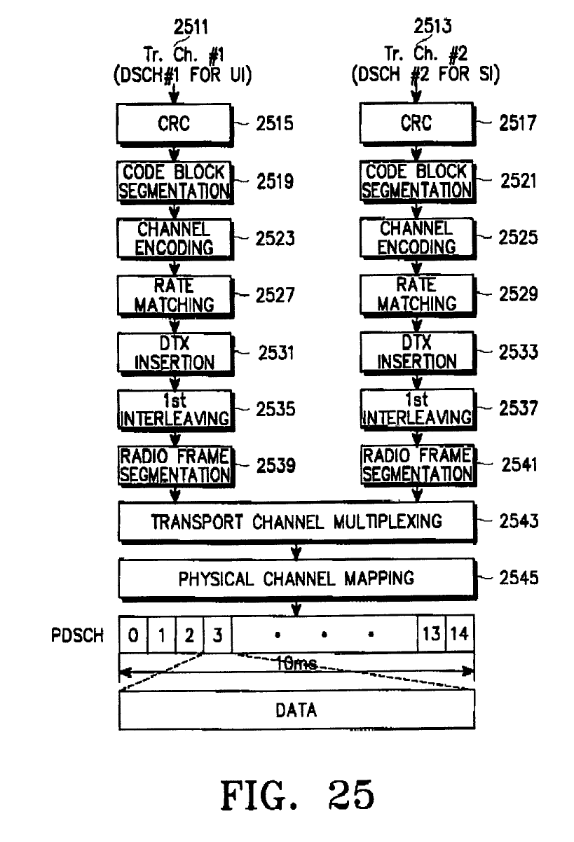

FIG. 25 illustrates a downlink channel structure for retransmission of the packet data in a HARQ scheme according to another embodiment of the present invention. If transmission errors have occurred in the user information UI and the side information SI transmitted over the 2 transport channels as described in FIG. 24, the Node B will retransmit the failed user information and side information. The failed user information and side information are retransmitted using the physical channel and the transport channel different from that used for initially transmitting the RLC-PDU, thus having an effect of using a separate transport channel for retransmitting only the failed RLC-PDUs. Herein, the DSCH is used for the separate transport channel for retransmitting the failed RLC-PDUs.

Referring to FIG. 25, the upper layer creates the initially transmitted user information UI and side information SI stored therein as user information (2511) and side information (2513) for retransmission. The created user information and side information to be retransmitted are mapped with the PDSCH through the different transport channels DSCH#1 and DSCH#2 before transmission. CRC codes are added to the created user information and side information to be retransmitted in a unit of the transport block generated from the transport channel (Steps 2515 and 2517). After CRC adding, the Node B segments the CRC-added data into code blocks for an FEC code (Steps 2519 and 2521), and performs channel encoding on the segmented code blocks for channel transmission at a channel coding rate of 1, ½ or ⅓ (Steps 2523 and 2525). The Node B performs rate matching in consideration of a length and a spreading factor of a physical frame in order to actually transmit the channel-encoded data blocks to the physical layer (Steps 2527 and 2529). The rate matching process is equivalent to performing puncturing and repetition on the data blocks received from the upper layer. The Node B performs DTX insertion on the rate-matched data blocks in order to discontinue data transmission when the downlink has no data to transmit to the UE instantaneously (Steps 2521 and 2533). After the DTX insertion process, the Node B performs interleaving to prevent burst errors (Steps 2535 and 2537). After interleaving, the Node B segments the interleaved data blocks into radio frames and provides the final radio frames to a transport channel multiplexer (Steps 2539 and 2541). The user information and the side information are subjected to transport channel multiplexing (Step 2543) and thereafter, subjected to physical channel mapping (Step 2545). The physical channel mapping process is varied according to the physical channel used for the retransmission. In case of FIG. 25, the Node B retransmits the failed RLC-PDU through the PDSCH physical channel using the DSCH transport channels. The downlink PDSCH for retransmitting the failed RLC-PDU is comprised of 15 10 ms-slots having a slot number of 0 to 14, wherein each slot is mapped with only the user information and the side information for controlling the user information transmitted over the PDSCH is always transmitted over the DPCH. Therefore, the PDSCH must be used together with the DPCH. Thus, the DPCH is called an “associated DPCH”.

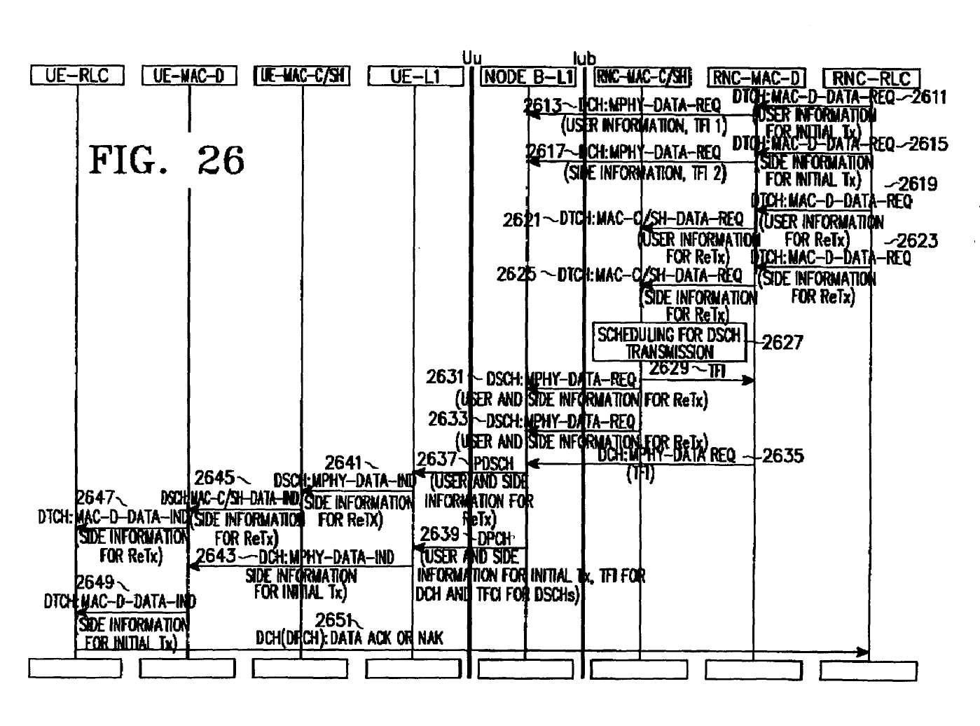

FIG. 26 illustrates a process for retransmitting the downlink packet data in a HARQ scheme according to another embodiment of the present invention. The retransmission process will be described with reference to the downlink channel structure described in FIGS. 24 and 25. Now, with reference to FIG. 26, the initial transmission process and the retransmission process of the RLC-PDU in the HARQ scheme will be described referring to a call processing process between the respective layers.

Referring to FIG. 26, when user information UI and side information SI are generated, an upper layer RNC-RLC transmits a primitive for initial transmission of the generated user information to an RNC-MAC-D layer (Step 2611), and transmits a primitive representative of the generated side information for controlling the user information to the RNC-MAC-D layer (Step 2615). The primitives exchanged between the RNC-RLC layer and the RNC-MAC-D layer represent information on the logical channels.

Further, FIG. 26 shows a structure in which one RNC-RLC transmits the user information UI and the side information SI through 2 separate transport channels, which means that one RLC layer controls 2 transport channels. Though not illustrated in FIG. 26, in an alternative embodiment, 2 RLC layers may control 2 transport channels separately. Upon receipt of the user information and the side information from the RNC-RLC layer, the RNC-MAC-D layer transmits primitives representative of the received user information and side information to a Node B-L1 (Steps 2613 and 2617). Since a dedicated traffic channel (DTCH) is used in steps 2611 and 2615, the RNC-MAC-C/SH layer is bypassed. The steps 2611 to 2617 show a signal flow for initial transmission of the RLC-PDU, and the succeeding steps 2619 to 2651 show a signal flow illustrating a process for retransmitting the retransmission-requested RLC-PDU upon receipt of a retransmission request message for requesting retransmission of the initially transmitted RLC-PDU.

In the process of retransmitting the RLC-PDU, the RNC-RLC layer transmits primitives to the RNC-MAC-D layer (Steps 2619 and 2623), when performing retransmission on the failed part of the RLC-PDU transmitted in the steps 2611 and 2615. The information included in the primitive transmitted in the steps 2619 and 2623 includes the side information SI and the user information UI, and they are transmitted to the RNC-MAC-D layer using the separate logical channels DTCH. Thereafter, RNC-MAC-D layer transmits the received user information and side information to the RNC-MAC-C/SH layer (Steps 2621 and 2625). The RNC-MAC-C/SH layer then performs DSCH scheduling by analyzing the received primitives (Step 2627). In the DSCH scheduling process, the RNC-MAC-C/SH layer transmits TFI (Transport Format Indicator) to the RNC-MAC-D layer in order to generate DCH for controlling the information to be transmitted over the DSCH (Step 2629). Here, the TFI includes side information for the information to be transmitted over the DSCH. In addition, since the DCH is a dedicated channel, the RNC-MAC-D layer manages this function. After transmitting the TFI to the RNC-MAC-D layer, the RNC-MAC-C/SH layer transmits transmission information to the Node B-L1 according to the DSCH scheduling function (Steps 2631 and 2633). At this point, the information transmitted to the Node B-L1 includes the failed initial RLC-PDUs. The RNC-MAC-D layer transmits a primitive to the Node B-L1 in order to transmit over the DCH the information constructed on the basis of the information provided according to the DSCH scheduling in step 2627 (Step 2635).

Upon receipt of the primitives, the Node B-L1 actually controls a physical channel between the Node B and the UE through a Uu interface which is an air interface between the Node B and the UE. The Node B-L1 transmits the user information and the side information of the failed RLC-PDUs to the corresponding UE-L1 through the PDSCH (Step 2637), and transmits the user information and the side information of the RLC-PDUs initially transmitted according to the PDSCH transmission to the UE-L1 through the DPCH (Step 2639). Here, the DPCH is an associated DPCH including the information for controlling the information transmitted over the DSCH, and transmits the side information received in step 2635 by the Node B-L1 always using the associated DPCH when using the PDSCH. Upon receipt of the information from the Node B-L1 through the PDSCH and the DPCH, the UE-L1 transmits a primitive to a UE-MAC-C/SH layer in order to indicate that its physical layer has received the PDSCH (Step 2641), and transmits a primitive to a UE-MAC-D layer in order to indicate reception of the DPCH (Step 2643). That is, the UE-L1 transmits the failed RLC-PDUs to the MAC-C/SH layer in step 2641, and transmits the initial RLC-PDUs to the MAC-D layer in step 2643. Upon receipt of the primitive indicating reception of the PDSCH from the UE-L1, the UE-MAC-C/SH layer transmits the received information to the UE-MAC-D layer (Step 2645), and the UE-MAC-D layer then reports the information received from the UE-MAC-C/SH layer to a UE-RLC layer (Steps 2647 and 2649).

The UE-RLC layer then transmits a response to the RLC-PDU received from the Node B to the RNC-RLC layer (Step 2651). For example, if an error has occurred in the RLC-PDU received from the Node B, the UE-RLC layer transmits a retransmission request NAK to the Node B, or otherwise, transmits an ACK signal. Upon receipt of the retransmission request message NAK from the UE-RLC layer, the RNC-RLC layer analyzes the received retransmission request message NAK and the sequence number, and retransmits the RLC-PDU according to the analysis results in steps 2619 and 2623. When retransmitting the RLC-PDU, the Node B (or transmitter) retransmits the sequence number and the version number of the RLC-PDU together with the user information.

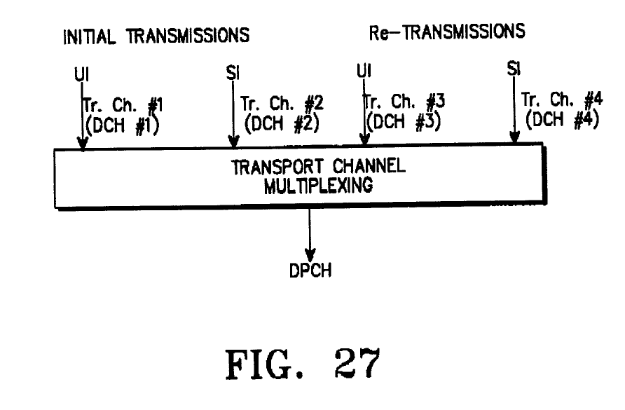

FIG. 27 illustrates an uplink channel structure for retransmission of the packet data in a HARQ scheme according to another embodiment of the present invention. Referring to FIG. 27, in the uplink (or reverse link), the UE transmits the RLC-PDU using the DPCH. In a TDD mode, the UE can use DPCH, USCH (Uplink Shared CHannel), or DPCH+USCH. However, in the embodiment where only the FDD mode is applied, the UE uses only the DPCH. Similarly to the downlink shown in FIG. 23, the UE uses the different transport channels DCH for initial transmission of the user information UI and the side information SI. For example, the user information is transmitted through the transport channel DCH#1 and the side information is transmitted through the transport channel DCH#2. The user information and the side information are mapped with one DPCH (Dedicated Physical CHannel) through the transport channel multiplexing. However, unlike the downlink, the uplink has no separate DSCH defined for retransmission, so that the uplink uses the same physical channel as that used for the initial transmission and uses separate transport channels, e.g., DCH#3 for the user information and, DCH#4 for the side information. Therefore, the uplink uses one physical channel DPCH and four transport channels DCH#1-DCH#4. Specifically, the uplink transmits the user information and the side information using the different transport channels during both the initial transmission and the retransmission.

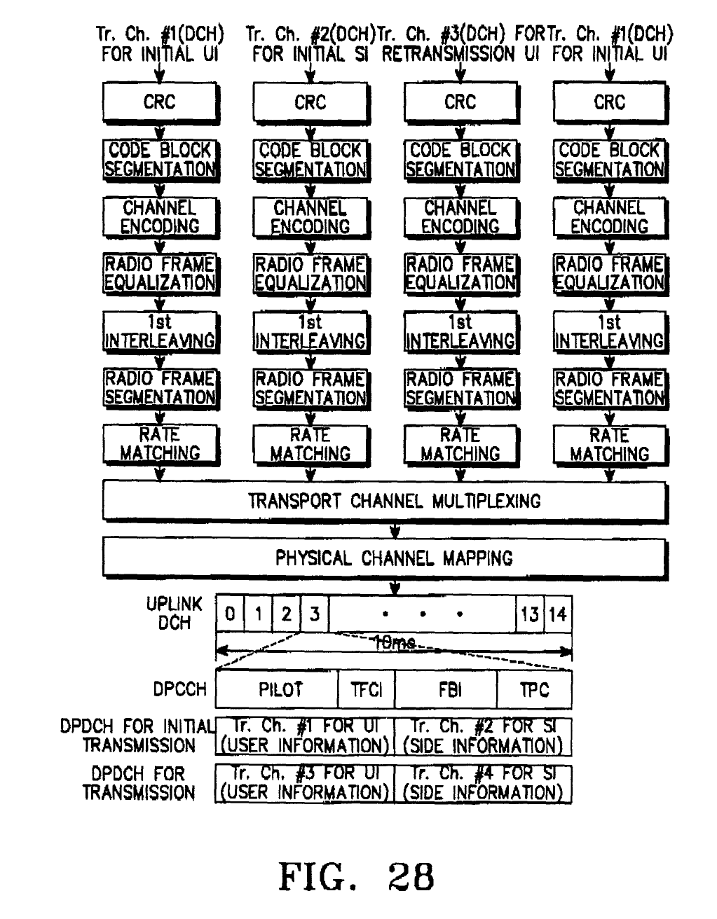

FIG. 28 illustrates an uplink channel structure for retransmission of the packet data in a HARQ scheme according to another embodiment of the present invention. The function blocks for processing the transport channels for the initial transmission and the retransmission of the RLC-PDU in the uplink have the same operation as those in the downlink (see FIGS. 24 and 25). However, the uplink does not support the DTX insertion part of the downlink. This is because the uplink can transmit the DPCCH to the Node B even though there exists no DPDCH, since the DPCCH and the DPDCH are physically generated. However, in the downlink, the DPDCH and the DPCCH are transmitted to the UE on a TDD basis, so that when there exists no information to be transmitted over the DPDCH, that part is subjected to a DTX operation, obtaining the result of DTX insertion. Since the DPCCH and the DPDCH are comprised of different channels, they transmit different information. The DPCCH is comprised of information for controlling the DPDCH, such as PILOT, TFCI, FBI (FeedBack Information) and TPC. The DPDCH has different transmission formats for one case where it is comprised of only the initially transmitted RLC-PDUs and for another case where it is comprised of only the retransmitted RLC-PDUs. The UE can set up a maximum of 7 DPDCHs, and the DPDCH for transmitting the initially transmitted RLC-PDUs and the DPDCH for retransmitting the failed RLC-PDUs are comprised of different channels. Therefore, the information for controlling the information transmitted over the DPDCH is transmitted using the DPCCH.

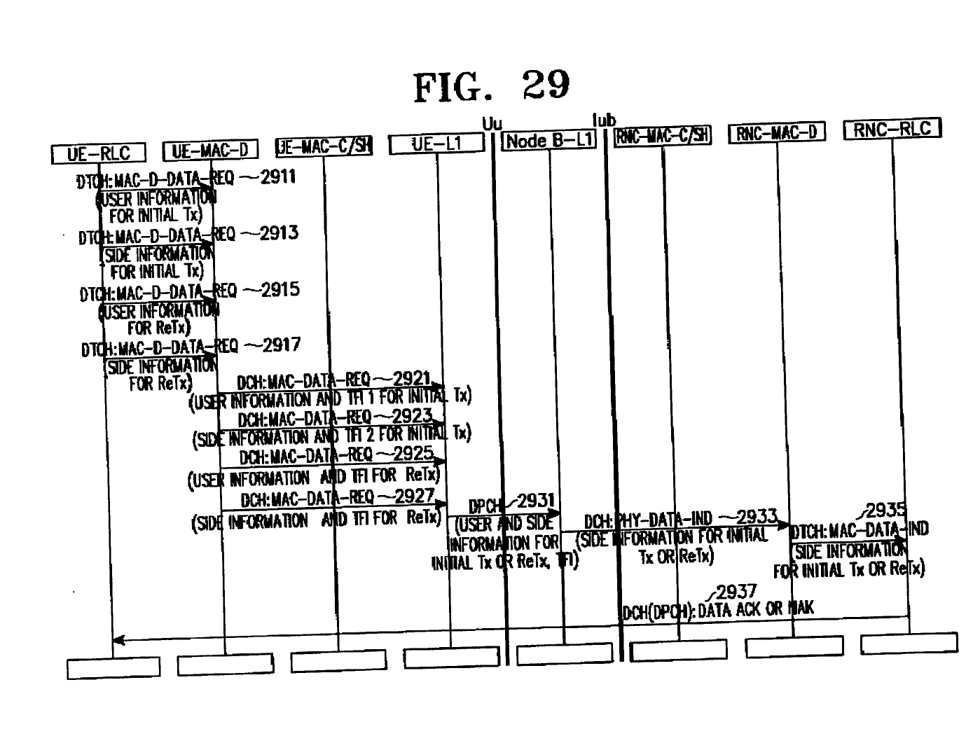

FIG. 29 illustrates a process for retransmitting uplink packet data in a HARQ scheme according to another embodiment of the present invention. Referring to FIG. 29, steps 2911, 2913, 2915 and 2917 indicate a process for transmitting primitives representative of user information UI and side information SI from the UE-RLC layer to the UE-MAC-D layer. To be concrete, the UE-RLC layer transmits a primitive representative of the initially transmitted user information to the UE-MAC-D layer in the step 2911, and transmits a primitive representative of the initially transmitted side information to the UE-MAC-D layer in the step 2913. Further, the UE-RLC layer transmits -a primitive for the retransmitted user information to the UE-MAC-D layer in step 2915, and transmits a primitive for the retransmitted side information to the UE-MAC-D layer in step 2917. Upon receipt of the primitives from the UE-RLC layer, the UE-MAC-D layer transmits the primitives to the UE-L1 (Steps 2921, 2923, 2925 and 2927). The steps 2921 and 2923 show a process for transmitting the primitives for the initially transmitted RLC-PDU, while the steps 2925 and 2927 show a process for transmitting the primitives for the retransmitted RLC-PDU. Upon receipt of the primitives from the UE-MAC-D layer, the UE-L1 transmits the user information and the side information related to the initially transmitted RLC-PDU and the user information and the side information related to the retransmitted RLC-PDU to the Node B-L1 through the DPCH (Step 2931). In step 2931, the Uu interface, an air interface, is used between the UE-L1 and the Node B-L1.

Upon receipt of the primitives through the UE-MAC-D layer, the Node B-L1 transmits a primitive indicating receipt of the DPCH to the RNC-MAC-D layer (Step 2933). As stated above, since the RNC-MAC-D layer manages control of the dedicated channel, the RNC-MAC-C/SH layer is bypassed. Upon receipt of the primitive indicating receipt of the DPCH from the Node B-L1, the RNC-MAC-D layer informs the RNC-RLC layer that the information has been received from the UE (Step 2935). If an error has occurred in the received RLC-PDU, the RNC-RLC layer transmits a retransmission request message NAK to the UE using a primitive (Step 2937). Upon receipt of the retransmission request message NAK, the UE retransmits the RLC-PDU matched with the sequence number of the RLC-PDU, included in the received retransmission request message NAK, together with its version number (Steps 2915 and 2917).

As described above, one RLC layer transmits the user information UI and the side information SI through two separate transport channels, which means that one RLC layer controls two transport channels. In an alternative embodiment, however, two RLC layer can control two transport channels.

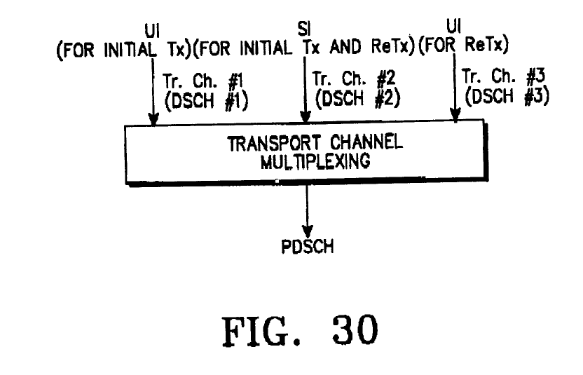

FIG. 30 illustrates a downlink channel structure for retransmission of the packet data in a HARQ according to another embodiment of the present invention. In the case of FIG. 30, the Node B transmits RLC-PDU to the UE through the downlink (or forward link), wherein the Node B transmits the RLC-PDU to the UE using one physical channel. In FIG. 30, the RLC-PDU has different transmission paths for initial transmission and retransmission. Further, FIG. 30 shows a mapping relationship between the transport channel and the physical channel, between the MAC layer and the physical layer.

The user information and the side information are transmitted through the different transport channels during initial transmission and retransmission. In the example shown in FIG. 30, during initial transmission, the user information is transmitted through the transport channel DSCH#1 and the side information is transmitted through the transport channel DSCH#2. The user information and the side information are mapped with one physical channel PDSCH (Physical Downlink Shared CHannel) through transport channel multiplexing. If an error has occurred in the RLC-PDU initially transmitted through the PDSCH, the initially transmitted RLC-PDU is retransmitted. Preferably, the retransmitted RLC-PDU should have a higher transmission guarantee (or success) rate compared with the initially transmitted RLC-PDU. To this end, a transport channel different from that used during initial transmission should be used to maintain the high transmission quality of the channels, thereby guaranteeing the higher transmission priority compared with the initially transmitted RLC-PDU. Therefore, the transport channel for transmitting the retransmitted RLC-PDU is different from the transport channel used during the initial transmission. In addition, since the side information SI is used for controlling the user information UI, it must be superior to the user information in the transmission quality. Therefore, the side information SI must be assigned to the transport channel different from the transport channel over which the user information UI is transmitted. Accordingly, as shown in FIG. 30, during retransmission of the RLC-PDU, the side information SI is assigned to the same channel as the transport channel over which the side information SI was transmitted during the initial transmission. That is, during retransmission, the user information UI is transmitted through the transport channel DSCH#3 and the side information SI is transmitted through the transport channel DSCH#2. The user information UI and the side information SI are mapped with one physical channel PDSCH through transport channel multiplexing, thereby retransmitting the failed initial RLC-PDUs. Since the side information SI has a higher transmission priority compared with the user information, the side information SI can use the same transport channel during both the initial transmission and the retransmission. FIG. 30 shows how to process the transport channels in the case where the transport channel DSCH#2, has a first priority and the transport channels DSCH#1 and DSCH#3 have a second priority. Although FIG. 30 shows a case where the packet data is transmitted to one UE, it is also possible to create a plurality of transport channels for retransmitting the packet data to a plurality of UEs.

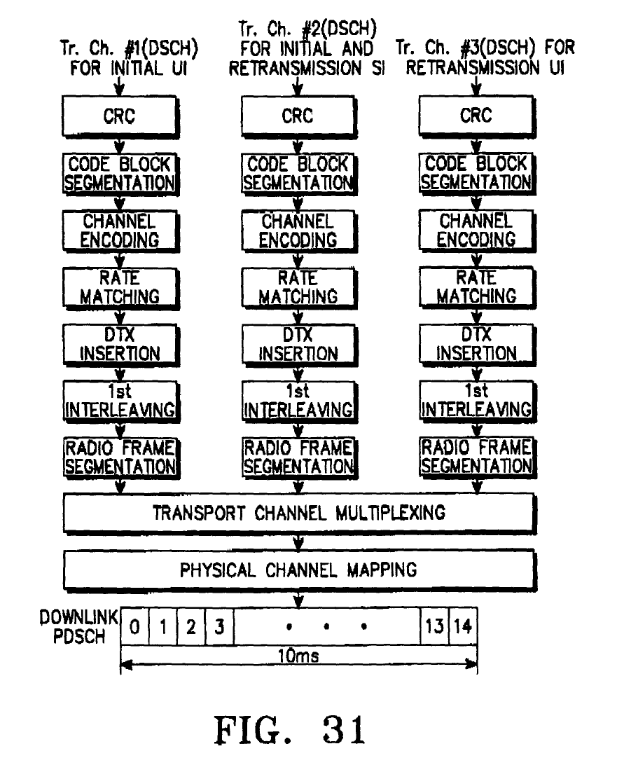

FIG. 31 illustrates a downlink channel structure for initial transmission and retransmission of the packet data in a HARQ scheme according to another embodiment of the present invention. Referring to FIG. 31, user information UI and side information SI are transmitted through different transport channels. For example, the initial user information is transmitted over the transport channel DSCH#1, the initial and retransmitted side information is transmitted over the transport channel DSCH#2, and the retransmitted user information is transmitted over the transport channel DSCH#3. CRC codes are added to the user information and the side information to be initially transmitted or retransmitted. The CRC is added in a unit of a transport block generated from the transport, channel. After CRC adding, the Node B segments the CRC-added data into code blocks for an FEC code, and then performs channel encoding on the segmented data for channel transmission at a channel coding rage of 1, ½ or ⅓. The Node B performs rate matching in consideration of a length and a spreading factor of a physical frame in order to actually transmit the channel-encoded data blocks to the physical layer. The rate matching process is equivalent to performing puncturing and repetition on the data blocks received from the upper layer. The Node B performs DTX insertion on the rate-matched data blocks in order to discontinue data transmission when the downlink has no data to transmit to the UE instantaneously. After the DTX insertion process, the Node B performs interleaving to prevent burst errors. After interleaving, the Node B segments the interleaved data blocks into radio frames and provides the final radio frames to a transport channel multiplexer. The user information and the side information are subjected to transport channel multiplexing and thereafter, subjected to physical channel mapping. The physical channel mapping process is varied according to the physical channel used for the retransmission.

In the case of FIG. 31, the Node B retransmits the failed RLC-PDU through the PDSCH physical channel using the DSCH transport channels. The downlink PDSCH for retransmitting the failed RLC-PDU is comprised of 15 10 ms-slots having a slot number of 0 to 14, wherein each slot is mapped with the user information and the side information.

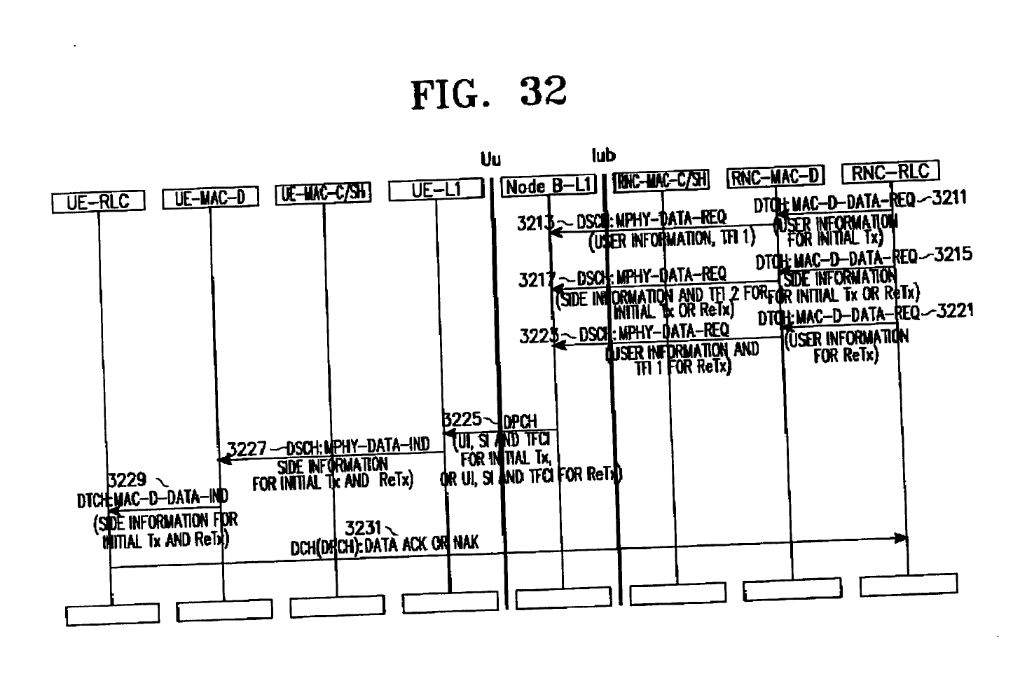

FIG. 32 illustrates a process for retransmitting the downlink packet data in a HARQ scheme according to another embodiment of the present invention. The retransmission process will be described with reference to the downlink channel structure described in FIGS. 30 and 31. Now, with reference to FIG. 32, the initial transmission process and the retransmission process of the RLC-PDU in the HARQ scheme will be described referring to a call processing process between the respective layers.

Referring to FIG. 32, when user information UI and side information SI are generated, an upper layer RNC-RLC transmits a primitive representative of the user information to an RNC-MAC-D layer (Step 3211), and transmits a primitive representative of the side information for controlling the user information to the RNC-MAC-D layer (Step 3215). The primitives exchanged between the RNC-RLC layer and the RNC-MAC-D layer represent information on the logical channels.

Further, FIG. 32 shows a structure in which one RNC-RLC transmits the user information UI and the side information SI through 2 separate transport channels, which means that one RLC layer controls 2 transport channels. Though not illustrated in FIG. 32, in an alternative embodiment, 2 RLC layers may control 2 transport channels separately. Upon receipt of the user information and the side information from the RNC-RLC layer, the RNC-MAC-D layer transmits the received user information and side information to a Node B-L1 (Steps 3213 and 3217). Since a dedicated traffic channel (DTCH) is used in steps 3211 and 3215, the RNC-MAC-C/SH layer is bypassed.

In the process of retransmitting the RLC-PDU, the RNC-RLC layer transmits primitives to the RNC-MAC-D layer (Steps 3215 and 3221), when performing retransmission on the failed part of the RLC-PDU transmitted in the steps 3211 and 3215. The side information SI transmitted in step 3215 is transmitted to the RNC-MAC-D layer using the same logical channel as that used during the initial transmission, while the user information UI transmitted in step 3221 is transmitted to the RNC-MAC-D layer using the logical channel different from that used during the initial transmission. The side information SI and the user information UI are then transmitted from the RNC-MAC-D layer to the Node B-L1 (Steps 3217 and 3223). Thereafter, the Node B-L1 transmits various information to the UE-L1 through the Uu interface, an air interface (Step 3225). Here, a substantial physical channel between the Node B-L1 and the UE-L1 becomes the PDSCH. Upon receipt of the user information and the side information from the Node B-L1, the UE-L1 stores the user information UI therein and transmits only the side information SI to the UE-MAC-D layer (Step 3227). The primitive transmitted in the step 3227 is used to inform the UE-MAC-D layer that the UE-L1 has received the PDSCH.

The UE-MAC-D layer provides the side information SI received from the UE-L1 to the UE-RLC layer (Step 3229), and the UE-RLC layer then transmits a response to the RLC-PDU received at the UE to the RNC-RLC layer (Step 3231). For example, if an error has occurred in the RLC-PDU received from the Node B-L1, the UE-RLC layer transmits a retransmission request NAK, or otherwise, transmits an ACK signal. Upon receipt of the retransmission request message NAK from the UE-RLC layer, the RNC-RLC layer analyzes the received retransmission request message NAK and the sequence number, and retransmits the RLC-PDU according to the analysis results in the steps 3215 and 3221. When retransmitting the RLC-PDU, the Node B (or transmitter) retransmits the sequence number and the version number of the RLC-PDU together with the user information.

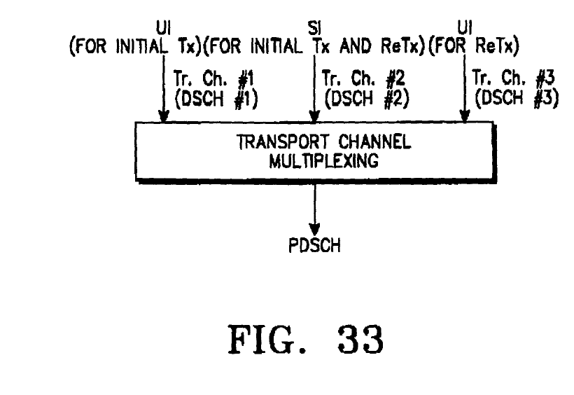

FIG. 33 illustrates an uplink channel structure for retransmission of the packet data in a HARQ scheme according to another embodiment of the present invention. Referring to FIG. 33, in the uplink (or reverse link), the UE transmits the RLC-PDU using the PDSCH. Similarly to the downlink shown in FIG. 30, the UE uses the different transport channels DSCH for initial transmission of the user information UI and the side information SI. For example, the user information is transmitted through the transport channel DSCH#1 and the side information is transmitted through the transport channel DSCH#2. The user information and the side information are mapped with one PDSCH (Physical Downlink Shared CHannel) through the transport channel multiplexing. Further, for retransmission, the uplink uses the same physical channel as that used for the initial transmission. In particular, to differentiate the transport channels, the side information SI uses the same transport channel DSCH#2 as that used for the initial transmission, while the user information UI uses a transport channel, e.g., DSCH#3 different from that used for the initial transmission. Therefore, the uplink uses one physical channel PDSCH and three transport channels DSCH#1-DSCH#3. Specifically, the uplink transmits the user information and the side information using the different transport channels during the initial transmission. However, during retransmission, the uplink transmits the side information using the transport channel over which the side information was transmitted during the initial transmission, and transmits the user information using the transport channel different from the transport channel over which the user information was transmitted during the initial transmission.

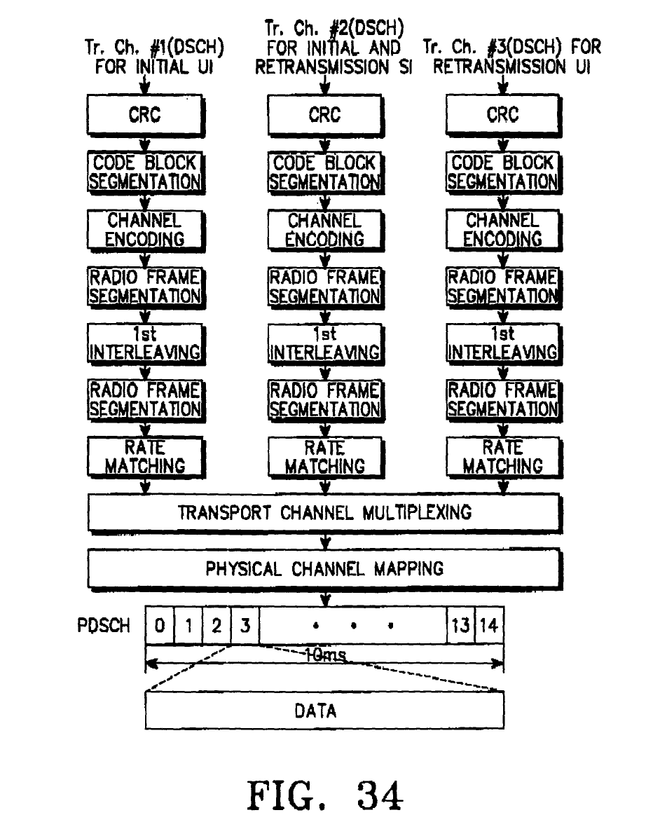

FIG. 34 illustrates an uplink channel structure for initial transmission and retransmission of the packet data in a HARQ scheme according to another embodiment of the present invention. The transport channel-related function blocks of FIG. 34, i.e., the CRC adding, segmentation and interleaving blocks are identical to the corresponding blocks shown in FIG. 31, so the detailed description will not be provided. However, the uplink does not support the DTX insertion part of the downlink. This is because the uplink can transmit the DPCCH to the Node B even though there exists no DPDCH, since the DPCCH and the DPDCH are physically generated. However, in the downlink, the DPDCH and the DPCCH are transmitted to the UE on a TDD basis, so that when there exists no information to be transmitted over the DPDCH, that part is subjected to a DTX operation, obtaining the result of DTX insertion. The user information and the side information are subjected to transport channel multiplexing and thereafter, subjected to physical channel mapping. The physical channel mapping process is varied according to the physical channel used for the retransmission. In case of FIG. 34, the UE retransmits the RLC-PDU through the PDSCH physical channel using the DSCH transport channel. The downlink PDSCH for retransmitting the failed RLC-PDU is comprised of 15 10ms-slots having a slot number of 0 to 14, wherein each slot is mapped with the user information and the side information.

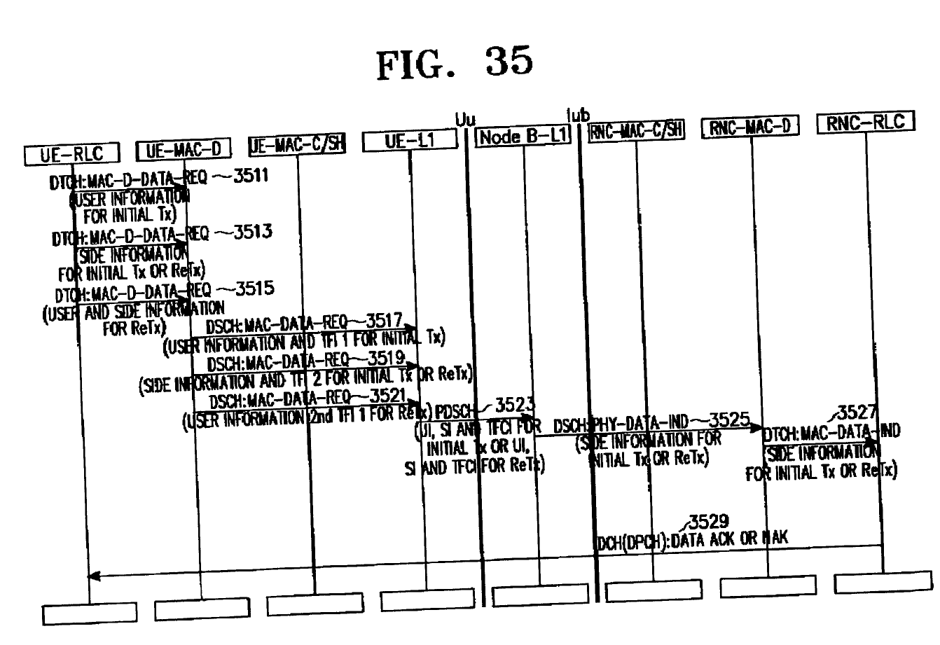

FIG. 35 illustrates a process for retransmitting uplink packet data in a HARQ scheme according to another embodiment of the present invention. Referring to FIG. 35, steps 3511, 3513 and 3515 indicate a process for transmitting primitives representative of user information and side information from the UE-RLC layer to the UE-MAC-D layer. The UE-RLC layer transmits the initially transmitted user information to the UE-MAC-D layer in the step 3511, and transmits the initially transmitted side information and the retransmitted side information to the UE-MAC-D layer in the step 3513. Further, in step 3515, the UE-RLC layer transmits the retransmitted user information to the UE-MAC-D layer. Upon receipt of the primitives from the UE-RLC layer, the UE-MAC-D layer transmits the received primitives to the UE-L1 (Steps 3517, 3519 and 3521). Specifically, the step 3517 shows a transport channel over which the user information of the initially transmitted RLC-PDU is transmitted, the step 3519 shows a transport channel over which the side information of the initially transmitted and retransmitted RLC-PDUs is transmitted, and the step 3521 shows a transport channel over which the user information of the retransmitted RLC-PDU is transmitted.

The UE's physical layer UE-L1 then transmits the user information and the side information related to the initially transmitted RLC-PDU and the user information and the side information related to the retransmitted RLC-PDU to the Node B's physical layer Node B-L1 through the Uu interface, an air interface (Step 3523). Here, a substantial physical channel between the Node B-L1 and the UE-L1 becomes the PDSCH. Upon receipt of the PDSCH from the UE-L1, the Node B-L1 transmits a primitive indicating receipt of the DPCH to the RNC-MAC-D layer (Step 3525). In other words, the Node B-L1 stores the received intact user information therein and transmits only the side information to the upper layer, i.e., the RNC-MAC-D layer. As stated above, since the RNC-MAC-D layer manages control of the dedicated channel, the RNC-,MAC-C/SH layer is bypassed. Upon receipt of the primitive indicating receipt of the DPCH from the Node B-L1, the RNC-MAC-D layer informs the RNC-RLC layer that the information has been received from the UE (Step 3527). If an error has occurred in the received RLC-PDU, the RNC-RLC layer transmits a retransmission request message NAK to the UE using a primitive (Step 3529). Upon receipt of the retransmission request message NAK, the UE retransmits the RLC-PDU matched with the sequence number of the RLC-PDU, included in the received retransmission request message NAK, together with its version number (Steps 3513 and 3515).

As described above, one RLC layer transmits the user information UI and the side information SI through two transport channels, which means that one RLC layer controls two transport channels. In an alternative embodiment, however, two RLC layer can control two transport channels.

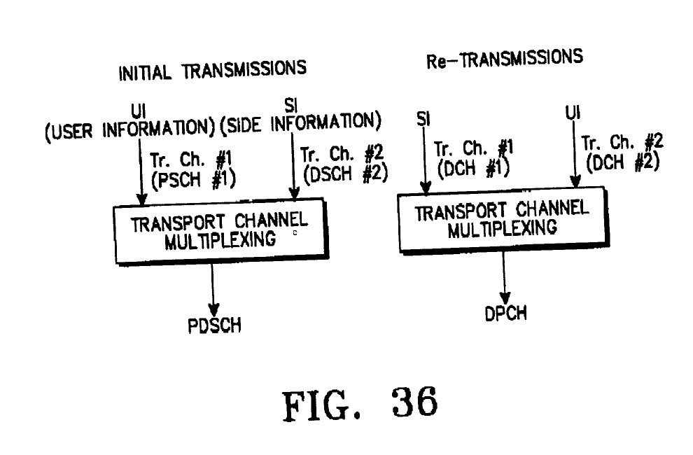

FIG. 36 illustrates a downlink channel structure for retransmission of the packet data in a HARQ scheme according to another embodiment of the present invention. In the case of FIG. 36, the Node B transmits RLC-PDU to the UE through the downlink (or forward link), wherein the Node B transmits the RLC-PDU to the UE using two physical channels. In FIG. 36, the RLC-PDU, a transmission unit of the HARQ scheme, has different transmission paths for initial transmission and retransmission. Further, FIG. 36 shows a mapping relationship between the transport channel and the physical channel, between the MAC layer and the physical layer.

The user information and the side information are transmitted through the different transport channels during initial transmission. In an example shown in FIG. 36, the user information UI is transmitted through the transport channel DSCH#1, while the side information SI is transmitted through the transport channel DSCH#2. The user information and the side information are mapped with one physical channel PDSCH (Physical Downlink Shared CHannel) through transport channel multiplexing. If an error has occurred in the RLC-PDU initially transmitted through the PDSCH, the initially transmitted RLC-PDU is retransmitted. In the retransmission process, the side information is transmitted over a transport channel DCH#1 and the user information is transmitted over a transport channel DCH#2. The user information and the side information are provided to a transport channel multiplexer through the transport channels DCHs, and the transport channel multiplexer then maps the DCHs with one physical channel DPCH through transport channel multiplexing, thereby retransmitting the failed initial RLC-PDU. Although FIG. 36 shows a case where the packet data is transmitted to one UE, it is also possible to create a plurality of transport channels for retransmitting the packet data to a plurality of UEs.

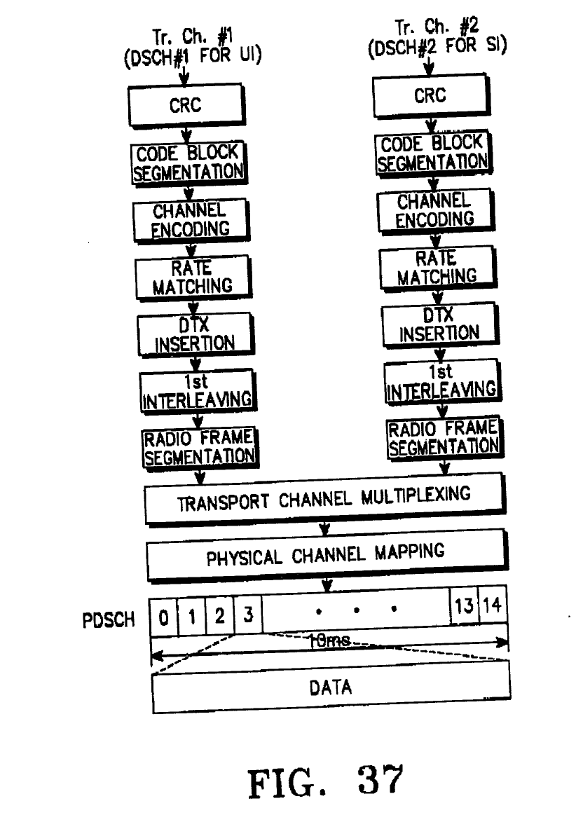

FIG. 37 illustrates a downlink channel structure for initial transmission of the packet data in a HARQ scheme according to another embodiment of the present invention. Referring to FIG. 37, user information UI and side information SI are transmitted through different transport channels. For example, the user information is transmitted over the transport channel DSCH#1 and the side information is transmitted over the transport channel DSCH#2. CRC codes are added to the user information and the side information. The CRC is added in a unit of a transport block generated from the transport channel. After CRC adding, the Node B segments the CRC-added data into code blocks for an FEC code, and then performs channel encoding on the segmented data for channel transmission at a channel coding rage of 1, ½ or ⅓. The Node B performs rate matching in consideration of a length and a spreading factor of a physical frame in order to actually transmit the channel-encoded data blocks to the physical layer. The rate matching process is equivalent to performing puncturing and repetition on the data blocks received from the upper layer. The Node B performs DTX (Discontinuous Transmission) insertion on the rate-matched data blocks in order to discontinue data transmission when the downlink has no data to transmit to the UE instantaneously. After the DTX insertion process, the Node B performs interleaving to prevent burst errors. After interleaving, the Node B segments the interleaved data blocks into radio frames and provides the final radio frames to a transport channel multiplexer. The user information and the side information are subjected to transport channel multiplexing and thereafter, subjected to physical channel mapping. The physical channel mapping process is varied according to the physical channel used for transmission. In FIG. 37, the Node B initially transmits the RLC-PDU over the PDSCH physical channel using the DSCH transport channels. The downlink PDSCH for retransmitting the RLC-PDU is comprised of 15 10 ms-slots having a slot number of 0 to 14, wherein each slot is mapped with the user information and the side information.

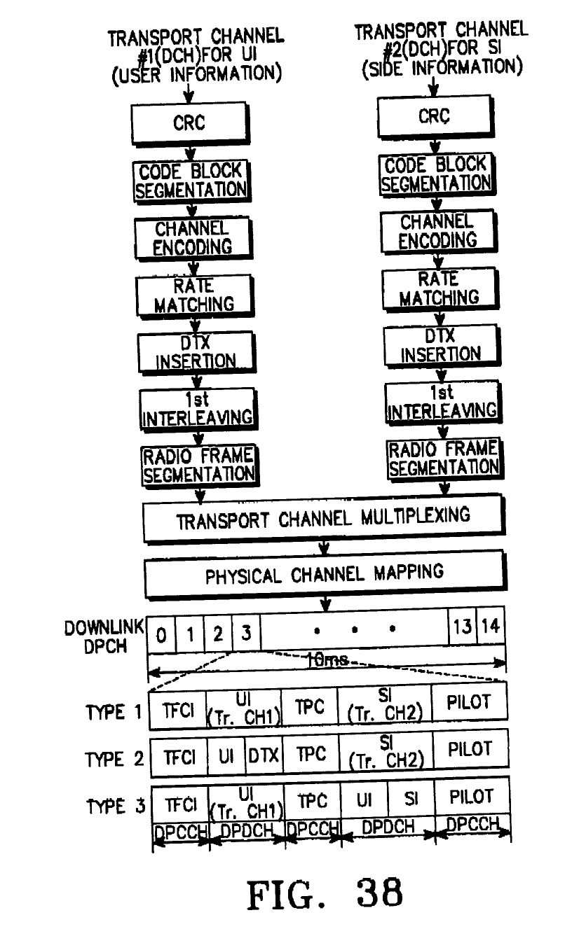

FIG. 38 illustrates a downlink channel structure for retransmission of the packet data in a HARQ scheme according to another embodiment of the present invention. Referring to FIG. 38, the upper layer creates the initially transmitted user information and side information stored therein as user information and side information for retransmission. The created user information and side information to be retransmitted are mapped with the DPCH through the different transport channels DCH#1 and DCH#2 before transmission. CRC codes are added to the created user information and side information to be retransmitted in a unit of the transport block generated from the transport channels. After CRC adding, the Node B segments the CRC-added data into code blocks for an FEC code, and then, performs channel encoding on the segmented code blocks for channel transmission at a channel coding rate of 1, ½ or ⅓. The Node B performs rate matching in consideration of a length and a spreading factor of a physical frame in order to actually transmit the channel-encoded data blocks to the physical layer. The rate matching process is equivalent to performing puncturing and repetition on the data blocks received from the upper layer. The Node B performs DTX insertion on the rate-matched data blocks in order to discontinue data transmission when the downlink has no data to transmit to the UE instantaneously. After the DTX insertion process, the Node B performs interleaving to prevent burst errors. After interleaving, the Node B segments the interleaved data blocks into radio frames and provides the final radio frames to a transport channel multiplexer. The user information and the side information are subjected to transport channel multiplexing and thereafter, subjected to physical channel mapping. The physical channel mapping process is varied according to the physical channel used for the retransmission. The downlink DPCH for retransmitting the failed RLC-PDU is comprised of 15 10 ms-slots having a slot number of 0 to 14, wherein each slot is comprised of DPCCHs (Dedicated Physical Control CHannels) and DPDCHs (Dedicated Physical Data CHannels).

The DPCCH includes side information for the data transmitted over the DPDCH, and is comprised of TFCI (Transport Format Combination Indicator), TPC (Transmit Power Control) and PILOT. Further, the DPDCH is a part to which the user information and the side information are actually mapped. The user information and the side information transmitted to the physical layer through the different transport channels are mapped with the DPDCH part of the DPCH, and then, transmitted to the E. The 3 types of the DPCH structure, shown in FIG. 38, are determined according to the information generated in the upper layer. The 3 types of the DPCH have fixed information formats. Actually, however, they are subjected to secondary interleaving after the transport channel multiplexing and the physical channel mapping, so that the user information and the side information may not be mapped with the DPCH in the fixed format.

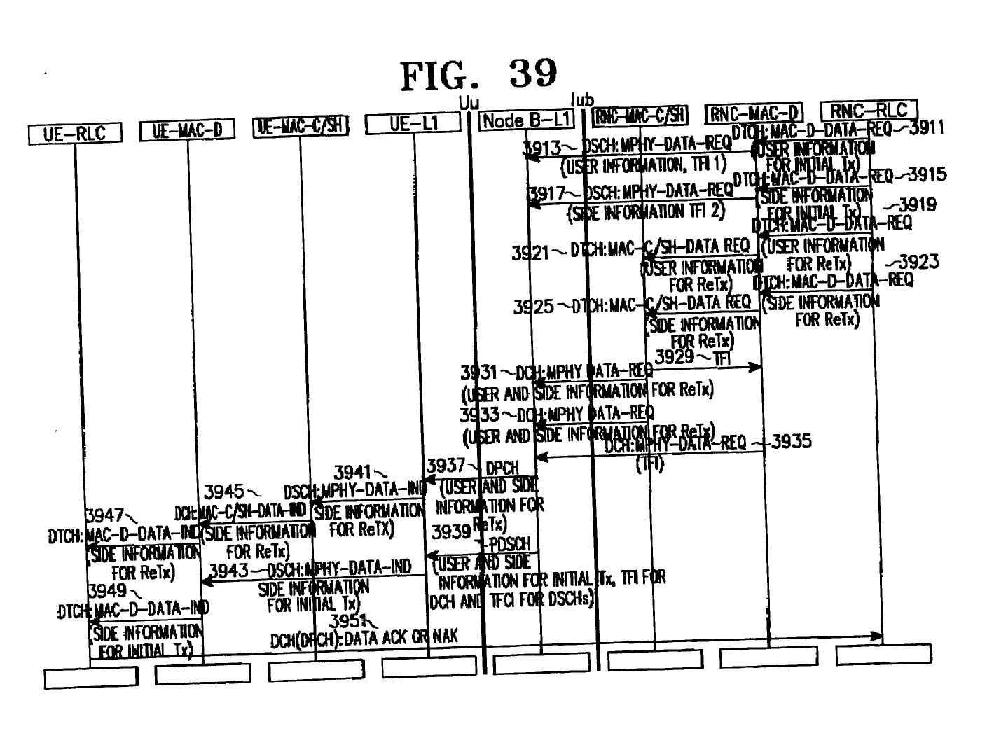

FIG. 39 illustrates a process for retransmitting the downlink packet data in a HARQ scheme according to another embodiment of the present invention. The retransmission process will be described with reference to the downlink channel structure described in FIGS. 37 and 38. Now, with reference to FIG. 39, the initial transmission process and the retransmission process of the RLC-PDU in the HARQ scheme will be described referring to a call processing process between the respective layers.

Referring to FIG. 39, when user information UI and side information SI are generated, an upper layer RNC-RLC transmits a primitive representative of the user information to an RNC-MAC-D layer (Step 3911), and transmits a primitive representative of the side information for controlling the user information to the RNC-MAC-D layer (Step 3915). The primitives exchanged between the RNC-RLC layer and the RNC-MAC-D layer represent information on the logical channels.

Further, FIG. 39 shows a structure in which one RNC-RLC transmits the user information UI and the side information SI through 2 separate transport channels, which means that one RLC layer controls 2 transport channels. Though not illustrated in FIG. 39, in an alternative embodiment, 2 RLC layers may control 2 transport channels separately. Upon receipt of the user information and the side information from the RNC-RLC layer, the RNC-MAC-D layer transmits primitives representative of the received user information and side information to a Node B-L1 (Steps 3913 and 3917). Since a dedicated traffic channel (DTCH) is used in steps 3911 and 3915, the RNC-MAC-C/SH layer is bypassed. The steps 3911 to 3917 show a signal flow for initial transmission of the RLC-PDU, and the succeeding steps 3919 to 3951 show a signal flow illustrating a process for retransmitting the retransmission-requested RLC-PDU upon receipt of a retransmission request message for requesting retransmission of the initially transmitted RLC-PDU.

In the process of retransmitting the RLC-PDU, the RNC-RLC layer transmits primitives to the RNC-MAC-D layer (Steps 3919 and 3923), when performing retransmission on the failed part of the RLC-PDU transmitted in the steps 3911 and 3915. The information included in the primitive transmitted in the steps 3919 and 3923 includes the side information SI and the user information UI, and they are transmitted to the RNC-MAC-D layer using the same logical channel DTCH. Thereafter, RNC-MAC-D layer transmits the received user information and side information to the RNC-MAC-C/SH layer (Steps 3921 and 3925). The RNC-MAC-C/SH layer then transmits TFI (Transport Format Indicator) to the RNC-MAC-D layer in order to generate DCH (Step 3929).

In addition, since the DCH is a dedicated channel, the RNC-MAC-D layer manages this function. After transmitting the TFI to the RNC-MAC-D layer, the RNC-MAC-C/SH layer transmits transmission information to the Node B-L1 through the DCHs (Steps 3931 and 3933). At this point, the information transmitted to the Node B-L1 includes the failed initial RLC-PDUs. The RNC-MAC-D layer transmits a primitive to the Node B-L1 in order to transmit the information over the DCHs (Step 3935).

Upon receipt of the primitives, the Node B-L1 controls an actual physical channel between the Node B and the UE through a Uu interface which is an air interface between the Node B and the UE. The Node B-L1 transmits the user information and the side information of the failed RLC-PDUs to the corresponding UE-L1 through the DPCH (Step 3937), and transmits the user information and the side information of the RLC-PDUs initially transmitted according to the DPCH transmission to the UE-L1 through the PDSCH (Step 3939). Upon receipt of the information from the Node B-L1 through the PDSCH and the DPCH, the UE-L1 transmits a primitive to a UE-MAC-C/SH layer in order to indicate that its physical layer has received the PDSCH (Step 3943), and transmits a primitive to a UE-MAC-D layer in order to indicate reception of the DPCH (Step 3941). That is, the UE-L1 transmits the failed RLC-PDUs to the MAC-C/SH layer in step 3941, and transmits the initial RLC-PDUs to the MAC-D layer in step 3943. Upon receipt of the primitive indicating reception of the PDSCH from the UE-L1, the UE-MAC-C/SH layer transmits the received information to the UE-MAC-D layer (Step 3945), and the UE-MAC-D layer then reports the received information to the UE-RLC layer (Steps 3947 and 3949).

The UE-RLC layer then transmits a response to the RLC-PDU received from the Node B to the RNC-RLC layer (Step 3951). For example, if an error has occurred in the RLC-PDU received from the Node B, the UE-RLC layer transmits a retransmission request NAK to the Node B, and otherwise, transmits an ACK signal. Upon receipt of the retransmission request message NAK from the UE-RLC layer, the RNC-RLC layer analyzes the received retransmission request message NAK and the sequence number, and retransmits the RLC-PDU according to the analysis results in steps 3919 and 3923. When retransmitting the RLC-PDU, the Node B (or transmitter) retransmits the sequence number and the version number of the RLC-PDU together with the user information.

In sum, the HARQ scheme according to the present invention retransmits the packet data using a new retransmission channel different from the channel used for initial transmission, thereby decreasing an error rate during retransmission of the packet data. Further, it is possible to increase expected throughput of the downlink by separately constructing the physical channel and the logical channel for exclusive use of retransmission. In addition, it is possible to reduce a delay time due to the repeated retransmission and also reduce the repetition frequency by improving the channel quality using the new retransmission channel. The reduction in retransmission frequency contributes to decreasing the memory capacity required for implementing the HARQ scheme, increasing utilization efficiency of the resources.

Further, by transmitting the packet data through the dedicated physical channel during initial transmission and retransmitting the packet data through the separate physical downlink shared channel (DSCH) during retransmission, it is possible to increase the retransmission priority contributing to an improvement of the throughput.

In addition, it is possible to prevent delay in transmitting the packet data by retransmitting the packet data through the physical downlink shared channel. Moreover, even in the uplink, it is possible to improve the throughput through an increase in the retransmission priority of the packet data by separately designating the transport channels for the initial transmission and retransmission of the packet data.

In addition, by directly transmitting the primitive from the RLC layer to the UE-L1, it is possible to reduce the delay time caused by the conventional process for transmitting the analyzed side information from the RLC layer to the RRC layer and then transmitting again the information from the RRC layer to the physical layer, and also reduce the system load caused when the RRC layer is enabled to transmit the side information to the physical layer each time the physical layer receives the user information.

Further, by transmitting the primitives from the RLC layer to the MAC-D layer and again transmitting the them from the MAC-D layer to the physical layer, it is possible to reduce the delay time caused by the conventional process for transmitting the analyzed side information from the RLC layer to the RRC layer and then transmitting again the information from the RRC layer to the physical layer, and also reduce the system load caused when the RRC layer is enabled to transmit the side information to the physical layer each time the physical layer receives the user information.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting packet data and side information including a sequence number of the packet data in a CDMA (Code Division Multiple Access) mobile communication system employing a HARQ (Hybrid Automatic Repeat reQuest) scheme for performing retransmission in response to a retransmission request message after an initial transmission, comprising the steps of:
transmitting the packet data and the side information over a common channel when performing the initial transmission; and
retransmitting the packet data and the side information over a dedicated channel.

2. The method as claimed in claim 1, wherein the common channel is a physical downlink shared channel (DSCH).

3. The method as claimed in claim 1, wherein the dedicated channel is a dedicated physical channel (DPCH).

4. A method for transmitting packet data and side information including a sequence number of the packet data in a CDMA mobile communication system employing a HARQ scheme for performing retransmission in response to a retransmission request message after an initial transmission, comprising the steps of:
transmitting the packet data over a dedicated channel; and
transmitting the side information over a common channel.

5. The method as claimed in claim 4, wherein the dedicated channel is a dedicated physical channel (DPCH).

6. The method as claimed in claim 4, wherein the common channel is a physical downlink shared channel (DSCH).

7. A method for transmitting packet data and side information including a sequence number of the packet data in a CDMA mobile communication system employing a HARQ scheme for performing retransmission in response to a retransmission request message after an initial transmission, comprising the steps of:
transmitting the packet data and the side information over a dedicated channel during the initial transmission; and
retransmitting the packet data and the side information over a common channel during the retransmission.

8. The method as claimed in claim 7, wherein the dedicated channel is a dedicated physical channel (DPCH).

9. The method as claimed in claim 7, wherein the common channel is a physical downlink shared channel (DSCH).

10. A method for transmitting packet data and side information including a sequence number of the packet data in a CDMA mobile communication system employing a HARQ scheme for performing retransmission in response to a retransmission request message after an initial transmission, comprising the steps of:
transmitting the packet data and the side information over a first dedicated channel during the initial transmission; and
transmitting the packet data and the side information over a second dedicated channel during the retransmission, the second dedicated channel being different from the first dedicated channel.

11. The method as claimed in claim 10, wherein the dedicated channel is a dedicated physical channel (DPCH).

12. A method for processing packet data in a mobile communication system in which a receiver including an RLC (Radio Link Control) layer, a MAC (Medium Access Control) layer and a physical layer, processes packet data received from a transmitter, the packet data and side information including a sequence number, comprising the steps of:
storing the packet data and transmitting the side information to the RLC layer through the MAC layer upon the physical layer's receiving the packet data and the side information from the transmitter;
transmitting a sequence number of the packet data, included in the side information, to the physical layer upon the RLC layer's receiving the side information; and
processing the stored packet data matching with the received sequence number and transmitting the processed packet data to the RLC layer through the MAC layer upon the physical layer's receiving the sequence number.

13. A HARQ method in a CDMA mobile communication system including a transmitter RLC layer for transmitting packet data generated in an upper layer to a receiver physical layer, said receiver physical layer for receiving the packet data and storing the received packet data, and a receiver RLC layer for detecting the packet data received at the receiver physical layer, comprising the steps of:
transmitting a primitive from the receiver RLC layer to the receiver physical layer, the primitive including an indicator indicating that packet data is stored in the receiver physical layer and also including a sequence number of the stored packet data; and
processing packet data matching with the sequence number and transmitting the processed packet data from the receiver physical layer to the receiver RLC layer upon the receiver physical layer's receiving the primitive.

14. A HARQ method in a CDMA mobile communication system including a transmitter RLC layer for transmitting packet data generated in an upper layer to a receiver physical layer, said receiver physical layer for receiving the packet data and storing the received packet data, and a receiver MAC layer and a receiver RLC layer for detecting the packet data received at the receiver physical layer, comprising the steps of:
transmitting a first primitive from the receiver RLC layer to the receiver MAC layer, the first primitive including an indicator indicating that packet data is stored in the receiver physical layer and also including a sequence number of the stored packet data;
transmitting a second primitive from the receiver MAC layer to the receiver physical layer upon the receiver MAC layer's receiving the first primitive, the second primitive including an indicator indicating that packet data is stored in the receiver physical layer and also including a sequence number of the stored packet data; and
processing packet data matching with a sequence number included in the second primitive and transmitting the processed packet data from the receiver physical layer to the receiver RLC layer upon the receiver physical layer's receiving the second primitive.

15. A method for transmitting packet data and side information including a sequence number of the packet data in a CDMA mobile communication system employing a HARQ scheme for performing retransmission in response to a retransmission request message after an initial transmission, comprising the steps of:
performing a first channel-processing of the packet data through a first transport channel and a first channel-processing of the side information through a second transport channel during the initial transmission;
multiplexing the first channel-processed packet data and side information and transmitting the multiplexed information over a dedicated channel during the initial transmission;
performing a second channel-processing of the side information through the second transport channel and a second channel-processing of the packet data through a third transport channel during the retransmission; and
multiplexing the second channel-processed packet data and side information and transmitting the multiplexed information over the dedicated channel during the retransmission.

16. The method as claimed in claim 15, wherein the dedicated channel is a dedicated physical channel (DPCH).

17. The method as claimed in claim 15, wherein the second transport channel,has a priority higher than a priority of the first and third transport channels.

18. A method for transmitting packet data and side information including a sequence number of the packet data in a CDMA mobile communication system employing a HARQ scheme for performing retransmission in response to a retransmission request message after an initial transmission, comprising the steps of:
performing a first channel-processing of the packet data through a first transport channel and a first channel-processing of the side information through a second transport channel during the initial transmission;
multiplexing the first channel-processed packet data and side information and transmitting the multiplexed information over a dedicated channel during the initial transmission;
performing a second channel-processing of the packet data through a third transport channel and a second channel-processing of the side information through a fourth transport channel during the retransmission; and
multiplexing the second channel-processed packet data and side information and transmitting the multiplexed information over a common channel during the retransmission.

19. The method as claimed in claim 18, wherein the dedicated channel is a dedicated physical channel (DPCH).

20. The method as claimed in claim 18, wherein the common channel is a physical downlink shared channel (DSCH).

21. A method for transmitting packet data and side information including a sequence number of the packet data in a CDMA mobile communication system employing a HARQ scheme for performing retransmission in response to a retransmission request message after an initial transmission, comprising the steps of:
performing a first channel-processing of the packet data through a first transport channel and a first channel-processing of the side information through a second transport channel during the initial transmission;
multiplexing the first channel-processed packet data and side information and transmitting the multiplexed information over a dedicated channel during the initial transmission;
performing a second channel-processing of the packet data through a third transport channel and a second channel-processing of the side information through a fourth transport channel during the retransmission; and
multiplexing the second channel-processed packet data and side information and transmitting the multiplexed information over the dedicated channel during the retransmission.

22. The method as claimed in claim 21, wherein the dedicated channel is a dedicated physical channel (DPCH).

23. A method for transmitting packet data and side information including a sequence number of the packet data in a CDMA mobile communication system employing a HARQ scheme for performing retransmission in response to a retransmission request message after an initial transmission, comprising the steps of:
performing a first channel-processing of the packet data through a first transport channel and a first channel-processing of the side information through a second transport channel during the initial transmission;
multiplexing the first channel-processed packet data and side information and transmitting the multiplexed information over a common channel during the initial transmission;
performing a second channel-processing of the side information through the second transport channel and a second channel-processing of the user information through a third transport channel during the retransmission; and
multiplexing the second channel-processed packet data and side information and transmitting the multiplexed information over the common channel during the retransmission.

24. The method as claimed in claim 23, wherein the common channel is a physical downlink shared channel (DSCH).

25. The method as claimed in claim 23, wherein the second transport channel has a priority higher than a priority of the first and third transport channels.

26. A method for transmitting packet data and side information including a sequence number of the packet data in a CDMA mobile communication system employing a HARQ scheme for performing retransmission in response to a retransmission request message after an initial transmission, comprising the steps of:
performing a first channel-processing of the packet data through a first transport channel and a first channel-processing of the side information through a second transport channel during the initial transmission;
multiplexing the first channel-processed packet data and side information and transmitting the multiplexed information over a common channel during the initial transmission;
performing a second channel-processing of the packet data through a third transport channel and a second channel-processing of the side information through a fourth transport channel during the retransmission; and
multiplexing the second channel-processed packet data and side information and transmitting the multiplexed information over a dedicated channel during the retransmission.

27. The method as claimed in claim 26, wherein the common channel is a physical downlink shared channel (DSCH).

28. The method as claimed in claim 26, wherein the dedicated channel is a dedicated physical channel (DPCH).

29. A method for transmitting packet data and side information including a sequence number of the packet data in a CDMA mobile communication system employing a HARQ scheme for performing retransmission in response to a retransmission request message after an initial transmission, comprising the steps of:
performing a first channel-processing of the packet data through a first transport channel and a first channel-processing of the side information through a second transport channel during the initial transmission;
multiplexing the first channel-processed packet data and side information and transmitting the multiplexed information over a dedicated channel during the initial transmission;
performing a second channel-processing of the packet data and a second channel-processing of the side information through a third transport channel during the retransmission; and
multiplexing the second channel-processed packet data and side information and transmitting the multiplexed information over the dedicated channel during the retransmission.

30. The method as claimed in claim 29, wherein the dedicated channel is a dedicated physical channel (DPCH).
